(19) United States
(12) Patent Application Publication
(10) Pub. No.: US 2024/0427999 A1
(43) Pub. Date: Dec. 26, 2024

(54) CONTEXT LLM RESPONSE SYSTEM

(71) Applicant: Satisfi Labs Inc., Tampa, FL (US)

(72) Inventors: Randy Newman, Tampa, FL (US); Don White, Tampa, FL (US)

(21) Appl. No.: 18/748,515

(22) Filed: Jun. 20, 2024

Related U.S. Application Data
(60) Provisional application No. 63/509,181, filed on Jun. 20, 2023.

(51) Int. Cl. G06F 40/30; G06F 16/955

(52) U.S. Cl. CPC G06F 40/30; G06F 16/955

(57) ABSTRACT

A computing device can receive a first conversational input of one or more sequential conversational inputs via one or more user input devices. The first conversational input can be associated with a particular uniform resource locator (URL) address. The computing device can process the first conversational input using one or more natural language processing algorithms to determine one or more intents based on the first conversational input. The computing device can select one or more data segments from a data store based on the intents. The computing device can generate a command including the data segments. The computing device can generate a generative response by performing the command with a generative artificial intelligence algorithm. The computing device can provide a response to the first conversational input based on the generative response.

### CROSS-REFERENCE TO RELATED APPLICATIONS

This application claims the benefit of and priority to U.S. Provisional Patent Application No. 63/509,181, filed on Jun. 20, 2023, and entitled “CONTEXT LLM RESPONSE SYSTEM,” the disclosure of which is incorporated by reference in its entirety as if the same were fully set forth herein.

### TECHNICAL FIELD

The present systems and processes relate generally to natural language processing (NLP) and, more specifically, to artificial intelligence platforms for generating context-based responses using large language models.

### BACKGROUND

Previous approaches to natural language processing and response generation have faced challenges in the areas of multi-turn context, consistency, knowledge management, and response synthesis. For example, previous approaches to natural language processing may demonstrate significant limitations in precision and accuracy when handling inputs that are contextually similar but compositionally dissimilar. As another example, previous platforms for processing and responding to conversational inputs are typically not robust to variations in natural language (e.g., there may be hundreds to thousands of manners for expressing the same intent and previous approaches may only recognize a highly limited subset thereof). Past approaches to NLP-based services commonly limit natural language inputs and natural language responses to a limited set of predetermined options. Such approaches may feel unnatural and robotic and may fail to accommodate the full spectrum of natural language compositions, contexts, and intents. In other words, previous contextual response systems may lack flexibility and dynamic capacity that would otherwise provide for a context- and intent-accurate conversational experience.

Therefore, there is a long-felt but unresolved need for an improved system or process for context-based natural language processing.

### BRIEF SUMMARY OF THE DISCLOSURE

Briefly described, and according to one embodiment, aspects of the present disclosure generally relate to systems and processes for context-based natural language processing. The disclosed system can include a contextual response system for processing natural language inputs and generating natural language responses based on the natural language inputs. The disclosed system can function as a virtual assistant on any particular user interface. For example, the disclosed system can function as a chatbot deployed onto a particular website. In another example, the disclosed system can function as a virtual speech assistant that generates natural language outputs as speech through telephonic/verbal communication.

The disclosed system can include one or more containers for receiving natural language inputs from a particular computing device. The containers can be defined as one or more user interfaces used to form a communication platform between the contextual response system and the computing device. The computing device can be any particular computer (e.g., desktop, tablet, cellphone, laptop, gaming console, etc.) that can communicate with the contextual response system through the containers. In one example, the container is a particular user interface that surfaces when the computing device activates a uniform resource locator (URL) address link. The container can accept natural language inputs to send to the contextual response system. The contextual response system can generate responses based on the natural language input received from the container. The contextual response system can send the response to the computing device to render the response within the container.

The disclosed system can process, analyze, and generate responses based on the received natural language inputs. The contextual response system can include a natural language processing (NLP) service for processing any information associated with the disclosed system. For example, the NLP service can extract contexts and intents from the input. The context of the input can be defined as a subject matter associated with the input. For example, a particular input can include, “Where can I find bars that serve liquor at Truist Park?” The context of the particular input in the previously stated example can include a context of “food and beverages.” The context of the input can function as a tag such that the contextual response system can identify associated resources for responding to the particular input. For example, each particular context can include associated resources stored and employed by the contextual response system for responding to inputs that have the associated context. The intent of the input can be defined as the identified reason or action associated with the input. For example, the intent of the particular input of the previously stated example can include the act of identifying bars that serve liquor at Truist Park. The contextual response system can identify contexts and intents to generate a response that properly respond to the one or more inputs.

The contextual response system can employ one or more machine learning models, natural language processing systems, and/or large language models (LLMs) for identifying contexts, identifying intents, analyzing inputs, and generating responses. The contextual response system can employ, for example, various LLMs to generate responses for the inputs received through the containers. The contextual response system can analyze responses to score the response accuracy, response quality, and/or any other metric associated with the particular response. The contextual response system can generate reports that identify trends and/or any particular discovered attribute associated with the data aggregated by the disclosed system.

The contextual response system can include a vector database for storing data with embedded vectors. The contextual response system can employ the embedded vectors to determine the similarities in words, phrases, contexts, intents, and/or any other particular data stored by the contextual response system. By employing embedded vectors, the contextual response system can identify information that is most pertinent to the particular input. For example, the contextual response system can generate an input embedded vector for a particular context of “Bathrooms at Truist Park.” Continuing this example, the contextual response system can compare the input embedded vector to other embedded vectors stored in the vector database to identify data associated with “Bathrooms at Truist Park.” On identifying the data most pertinent to the particular context based on the comparisons of one or more embedded vectors, the contextual response system can generate a response based on the identified data, send the identified data to one or more LLMs, or perform any particular action associated with the identified data.

The contextual response system can employ various forms of responses to respond to a particular input. The contextual response system, for example, can include an intent router to determine the response type best suited to respond to the particular input received through the container. For example, the intent router can employ various pre-written responses used to respond to inputs that require a response with a certain degree of accuracy and control. In such an example, the intent router can employ a response service to generate the response. In another example, the intent router can employ hybrid responses that include portions of pre-written text and one or more code snippets embedded into the response. The code snippets can include calls to the LLM to generate specific responses based on a subset of particular data and a specialized prompt.

The contextual response system can process data recovered from the vector database associated with the input to generate the specialized prompt. The specialized prompt can include a textual request made the LLM service that is specific to the data recovered from the vector database and the input. By using specialized responses, the LLM service can generate more accurate and specific responses while reducing the economic and latency cost associated with more general prompts.

In a non-limiting example, the disclosed system can function as a virtual assistant for processing questions, requests, and/or any particular input sent to the contextual response system. For example, the disclosed system can include a first container deployed on a particular website owned and operated by the Atlanta Braves®. The disclosed system can process questions associated with the Atlanta Braves®. For example, the container can receive a question asking, “Where is the nearest bathroom to section 115?” Continuing this example, the container can send the question to the contextual response system for processing and analysis. The contextual response system using, the NLP service and/or the LLMs, can generate a response that identifies the bathrooms nearest to section 115. For example, the contextual response system can generate a response that include a text description of where to walk to find the nearest bathroom and/or a geo-location enabled map that direct the computing device (e.g., cellphone) to the nearest bathroom.

These and other aspects, features, and benefits of the claimed innovation(s) will become apparent from the following detailed written description of the embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 shows an example contextual response workflow that may be performed by a contextual response system, according to one embodiment of the present disclosure;

FIG. 2 shows an example network environment in which a contextual response system may operate, according to one embodiment of the present disclosure;

FIG. 3 shows an example communication service and workflow, according to one embodiment of the present disclosure;

FIG. 4 shows an example response generation workflow, according to one embodiment of the present disclosure;

FIG. 5 shows a flowchart of a process, according to one embodiment of the present disclosure;

FIG. 6 shows a flowchart of a process, according to one embodiment of the present disclosure;

FIG. 7 shows a flowchart of a process, according to one embodiment of the present disclosure; and

FIG. 8 shows a flowchart of a process, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to systems and methods for context-based natural language processing. The disclosed system can include a contextual response system for processing natural language inputs and generating natural language responses based on the natural language inputs. The disclosed system can function as a virtual assistant on any particular user interface. For example, the disclosed system can function as a chat-bot deployed onto a particular website. In another example, the disclosed system can function as a virtual speech assistant that generates natural language outputs as speech through a telephonic/verbal communication.

The disclosed system can include one or more containers for receiving natural language inputs from a particular computing device. The containers can be defined as one or more user interfaces used to form a communication platform between the contextual response system and the computing device. The computing device can be any particular computer (e.g., desktop, tablet, cellphone, laptop, gaming console, etc.) that can communicate with the contextual response system through the one or more containers. In one example, the container is a particular user interface that surfaces when the computing device activates a uniform resource locator (URL) address link. The container can accept natural language inputs to send to the contextual response system. The contextual response system can generate responses based on the natural language input received from the container. The contextual response system can send the response to the computing device to render the response within the container.

The disclosed system can process, analyze, and generate responses based on the received natural language inputs. The contextual response system can include a natural language processing (NLP) service for processing any information associated with the disclosed system. For example, the NLP service can extract contexts and intents from the input. The context of the input can be defined as a subject matter associated with the input. For example, a particular input can include, “Where can I find bars that serve liquor at Truist Park?” The context of the particular input in the previously stated example can include a context of “food and beverages.” The context of the input can function as a tag such that the contextual response system can identify associated resources for responding to the particular input. For example, each particular context can include associated resources stored and employed by the contextual response system for responding to inputs that have the associated context. The intent of the input can be defined as the identified reason or action associated with the input. For example, the intent of the particular input of the previously stated example can include the act of identifying bars that serve liquor at Truist Park. The contextual response system can identify contexts and intents to generate a response that properly respond to the one or more inputs.

The contextual response system can employ one or more machine learning models, natural language processing systems, and/or large language models (LLMs) for identifying contexts, identifying intents, analyze inputs, and generate responses. The contextual response system can employ, for example, various LLMs to generate responses for the inputs received through the containers. The contextual response system can analyze responses to score the response accuracy, response quality, and/or any other metric associated with the particular response. The contextual response system can generate reports that identify trends and/or any particular discovered attribute associated with the data aggregated by the disclosed system.

The contextual response system can include a vector database for storing data with embedded vectors. The contextual response system can employ the embedded vectors to determine the similarities in words, phrases, contexts, intents, and/or any other particular data stored by the contextual response system. By employing embedded vectors, the contextual response system can identify information that is most pertinent to the particular input. For example, the contextual response system can generate an input embedded vector for a particular context of “Bathrooms at Truist Park.” Continuing this example, the contextual response system can compare the input embedded vector to other embedded vectors stored in the vector database to identify data associated with “Bathrooms at Truist Park.” On identifying the data most pertinent to the particular context based on the comparisons of one or more embedded vectors, the contextual response system can generate a response based on the identified data, send the identified data to one or more LLMs, or perform any particular action associated with the identified data.

The contextual response system can employ various forms of responses to respond to a particular input. The contextual response system, for example, can include an intent router to determine the response type best suited to respond to the particular input received through the container. For example, the intent router can employ various pre-written responses used to respond to inputs that require a response with a certain degree of accuracy and control. In such an example, the intent router can employ a response service to generate the response. In another example, the intent router can employ hybrid responses that include portions of pre-written text and one or more code snippets embedded into the response. The code snippets can include calls to the LLM to generate specific responses based on a subset of particular data and a specialized prompt.

The contextual response system can process data recovered from the vector database associated with the input to generate the specialized prompt. The specialized prompt can include a textual request made the LLM service that is specific to the data recovered from the vector database and the input. By using specialized responses, the LLM service can generate more accurate and specific responses while reducing the economic and latency cost associated with more general prompts.

In a non-limiting example, the disclosed system can function as a virtual assistant for processing questions, requests, and/or any particular input sent to the contextual response system. For example, the disclosed system can include a first container deployed on a particular website owned and operated by the Atlanta Braves®. The disclosed system can process questions associated with the Atlanta Braves®. For example, the container can receive a question asking, “Where is the nearest bathroom to section 115?” Continuing this example, the container can send the question to the contextual response system for processing and analysis. The contextual response system using, the NLP service and/or the LLMs, can generate a response that identifies the bathrooms nearest to section 115. For example, the contextual response system can generate a response that include a text description of where to walk to find the nearest bathroom and/or a geo-location enabled map that direct the computing device (e.g., cellphone) to the nearest bathroom.

### Example Embodiments

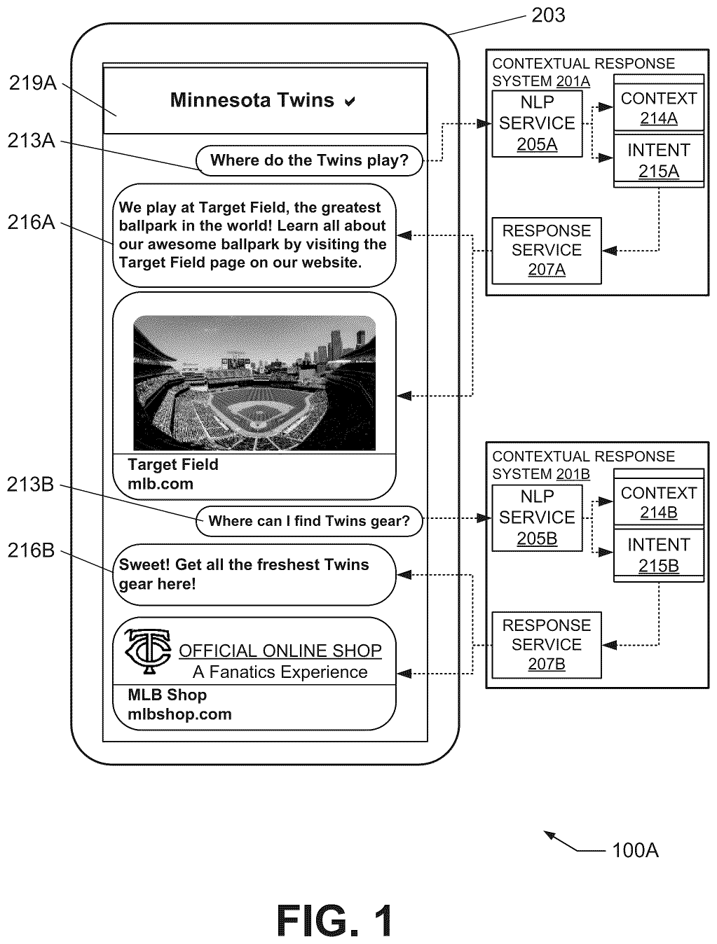

Referring now to the figures, for the purposes of example and explanation of the fundamental processes and components of the disclosed systems and processes, reference is made to an example contextual response workflow 100A, as illustrated in FIG. 1. The example contextual response workflow 100A can be performed by an embodiment of a contextual response system 201 shown and described herein.

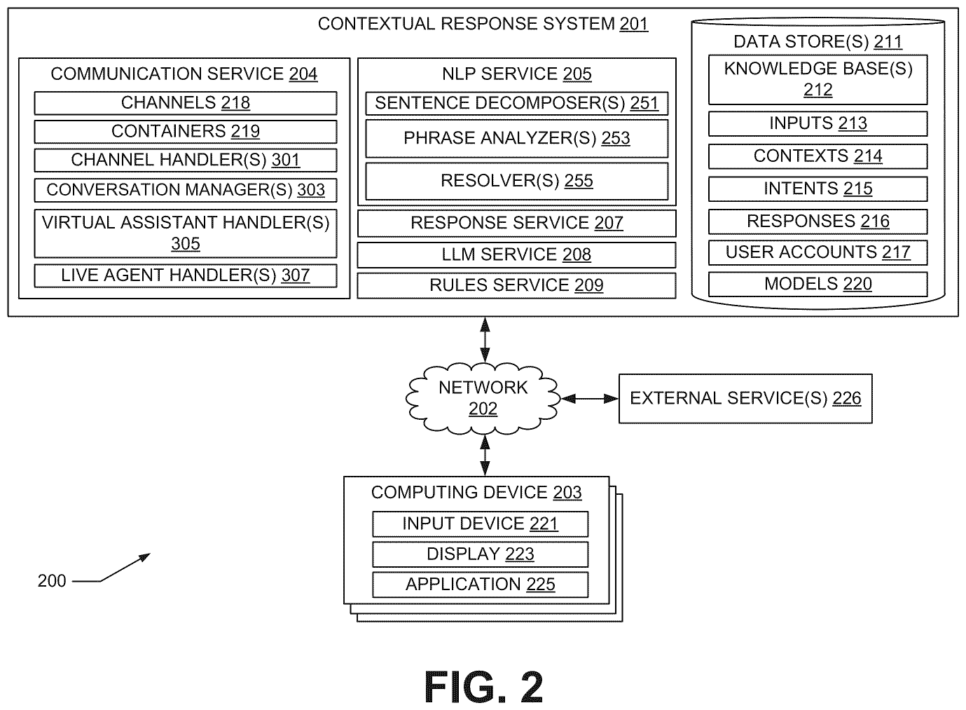

For purposes of illustrating and describing example aspects of the present technology, FIG. 1 can include contextual response systems 201A and 201B. As will be understood and appreciated, the contextual response systems 201A and 201B may represent a single contextual response system (e.g., the contextual response system 201) or multiple contextual response systems in communication over one or more networks 202 (see FIG. 2). As will be understood and appreciated, the example contextual response systems 201A and 201B shown in FIG. 1 and other accompanying figures may each represent merely one approach or embodiment of the present contextual response system, and other aspects are used according to various embodiments shown and described herein. According to one embodiment, the lettering convention of elements shown in FIG. 1 may indicate a temporal sequence of actions performed by the corresponding element. For example, in FIG. 1, the NLP service 205A and NLP service 205B may refer to the same NLP service (e.g., the NLP service 205B representing an iteration of the NLP service subsequent to the NLP service 205A). Further continuing this example, the NLP service 205A and the NLP service 205B can be the same NLP service (e.g., an NLP service 205) performing different actions at different moments in time.

The workflow 100A may be performed by contextual response systems 201A and 201B. As further shown in FIG. 2 and described herein, the contextual responses systems 201A and 201B may communicate with one or more computing devices 203. The contextual responses systems 201A and 201B can receive inputs from the computing device 203, such as text strings including natural language. The contextual response systems 201A and 201B can process the inputs to generate responses thereto. The contextual responses systems 201A and 201B can transmit the responses to the computing device 203 from which input was received, or to one or more additional computing devices. Though describe separately, the contextual response systems 201A and 201B can represent two distinct instances of the singular contextual response system 201 (see FIG. 2).

The contextual response systems 201A and 201B may correspond to the contextual response system 201 shown in FIG. 2 and described herein. In addition to other elements shown in FIG. 2 and described herein, the contextual response systems 201A and 201B may include, but are not limited to, the NLP services 205A, 205B and response services 207A, 207B. The NLP service 205A, 205B can receive inputs associated with a computing device 203. The input can be any electronic communication and may include natural language, such as text strings or audio recordings. The NLP service 205A and 205B can process the inputs to determine one or more of a context of the input, an intent of the input, and a level of granularity of the input. The context of the input can refer to a set of standalone resources for generating responses to context-associated inputs. As one example, a “Venue” context may include a set of resources for responding to inputs associated with one or more venues, and a “Merchandise” context may include a set of resources for responding to inputs associated with one or more goods for sale. The intent of the input can refer to a desired action and object of the action. The intent can be associated with a context. For example, an “access venue location” intent can refer to a desire to access a location of a venue (e.g., the venue being associated with the “Venue” context). As another example, a “buy player jersey” intent can refer to a desire to purchase merchandise (e.g., the merchandise being associated with the “Merchandise” context). The level of granularity of the input can refer to an arbitrary level of specificity as compared to other inputs associated with the same context and/or intent. For example, a first input of “Can I buy a Mets jersey?” may be associated with a first level of granularity, and a second input of “Can I buy a Jacob deGrom jersey” may be associated a second level of granularity that is greater than the first level of granularity (e.g., Jacob deGrom being a pitcher on the roster of the Mets baseball team).

The response service 207A, 207B can generate a response to an input based on one or more of the context of the input, the intent of the input, and the level of granularity of the input. The response service 207A, 207B may generate a response at a highest level of granularity available (e.g., providing a response that is most specific to the corresponding input). The response service 207A, 207B can generate a response using one or more Large Language Models (LLMs) of an LLM service 208 (see FIG. 2), as discussed in further detail herein.

The contextual response systems 201A, 201B can include a first container 219A. The first container 219A can correspond to a container 219 as shown in FIG. 2 and described herein. The first container 219A includes a standalone deployment of resources for receiving inputs into the contextual response systems 201A, 201B, and for transmitting output therefrom to one or more computing devices 203. For example, the first container 219A can include a user interface (e.g., a surfaced chat box in an application) rendered on the computing device 203. Continuing this example, the first container 219A can be integrated as a selectable portal such that users can interact with the contextual response systems 201A and 201B. The first container 219A may include a deployment of resources associated with the contextual response system 201A, including one or more portals, mediums, or other means by which input is received into the contextual response system 201A. For example, the first container 219A can include a chatbox that can receive natural language from the user.

Multiple containers may be associated with different entities. For example, the first container 219A is associated with a first Major League Baseball (MLB) team, the Minnesota Twins, and a second container (not pictured) is associated with a second MLB team, the Oakland Athletics. Continuing this example, the computing device 203 can render the first container 219A and subsequently render the second container based on the received input. As described herein, the present contextual response system 201A, 201B may receive, process, and respond to inputs by the first container 219A. For example, the present contextual response systems 201A, 201B may receive and process input through the first container 219A and further process and respond to the input through the second container. The computing device 203 can render a selectable drop down menu for selecting any of the available containers.

The proceeding paragraphs describe the workflow 100A in reference to an example scenario of receiving and responding to natural language inputs. It will be understood and appreciated that the described functions and processes may represent one of a plurality of embodiments of the present technology and are not intended to restrict the systems and processes shown and described herein.

In an example scenario, the contextual response systems 201A and 201B are deployed as an artificial intelligence (AI) customer assistant for MLB teams, including the Minnesota Twins. A user of the computing device 203 can access a particular uniform resource locator (URL) address associated with the first container 219A. In another example, the computing device 203 may render a selectable portal that surfaces the first container 219A, the second container, and/or any other particular container 219. The computing device 203 can transmit an input 213A to the contextual response system 201A via the first container 219A. The contextual response system 201A can receive the input 213A via the first container 219A. The input 213A can include natural language from the user, such as “Where do the Twins play?”

The NLP service 205A processes the input 213A via one or more NLP algorithms, techniques, or modules and determines a context 214A. For example, the NLP service 205A can employ the LLM service 208 to determine the context 214A of the input 213A. In this scenario, the context 214A is “Venue Information.” The NLP service 205A may determine the context 214A based one or more factors including, but not limited to, the first container 219A by which the input 213A was received (e.g., including the URL address associated therewith), detections of the terms “where,” “Twins,” and/or “play, a detection of the phrase “where do the Twins play,” a detection of the question mark character “?,” and a context of one or more preceding inputs (not shown).

The NLP service 205A further processes the input 213A based on the context 214A to determine an intent 215A. The intent 215A includes a desired action and one or more objects, elements, or subjects associated with desired action. In this scenario, the intent 215A includes a desire to learn, obtain, and/or access venue information, in particular, a location of the venue. As shown in Table 1 and described herein, an intent may include a concatenation of various classes and/or detections generated by the contextual response system. A naming convention of the intent 215A may include “venue_information:venue_location-learn.” Using the previous example, the naming convention “venue_information:venue_location-learn” can define the context 214A as venue information (e.g., “venue_information”) and the intent 215A as the desire to learn the location of the venue (e.g., “venue_location-learn”).

The NLP service 205A can employ the LLM service 208 to determine the intent 215A of the input 213A. For example, the NLP service 205A can call an LLM Application Programming Interface (API) of the LLM service 208 to interface with a particular LLM (e.g., ChatGPT, BERT, LLAMA, LaMDA, etc.). Continuing this example, the NLP service 205A can send the LLM service 208 the input 213A to determine the intent 215A of the input 213A. Further continuing this example, the NLP service 205A can receive the predicted intent 215A from the LLM service 208. The NLP service 205A can evaluate and compare the predicted intent 215A generated by the LLM service 208 and the intent 215A generated by the NLP service 205A. The NLP service 205A can score the one or more intents 215A based on accuracy, conciseness, clarity, legitimacy, quality, and/or any particular metric. The NLP service 205A can select the intent 215A with the highest score for analysis and further processing.

The response service 207A can process the context 214A and the intent 215A to generate a response 216A. The response service 207A can generate one or more responses based on the context 214A and the intent 215A identified by the NLP service 205A. For example, the response 216A can include natural language, such as “We play at Target Field!” As further shown and described herein, the response service 207A may scan through one or more decision trees to identify a context- and intent-matching response (e.g., and including an emphasis on identifying a response associated with a highest possible level of granularity relative to the corresponding input). The response 216A may include one or more multimedia elements, such as a photo, video, or audio file. The response 216A may include one or more selectable links for accessing additional information or services, such as a URL address for accessing additional venue information.

The contextual response systems 201A and 201B can employ the LLM service 208 to generate the response 216A and 216B, respectively. For example, the NLP service 205A can process the input 213A by generating one or more embedded vectors for the input 213A. The NLP service 205A can, for example, use Word2Vec to generate one or more embedded vectors for each word of the input 213A, each phrase of the input 213A, the entire input 213A, and/or any particular component of the input 213A. By generating embedded vectors for any particular component of the input 213A, the NLP service 205A can generate a multi-dimensional space to plot the embedded vectors of the input 213A. The NLP service 205A can compare the embedded vectors of the input 213A to a vector database that stores one or more embedded vectors for all data gathered by the contextual response system 201A. The NLP service 205A can identify embedded vectors that are substantially similar (e.g., closest in distance in the multi-dimensional space) to aggregate pertinent data associated with the embedded vectors of the input 213A. On aggregating the pertinent data based on the perceived similarities in the embedded vectors, the NLP service 205A can send the pertinent data to the LLM service 208. On receiving the pertinent data from the NLP service 205A, the LLM service 208 can generate the response 216A to the input 213A in accordance with the pertinent data. By using the pertinent data to generate the response 216A, the LLM service 208 can more accurately respond to the input 213A by only using data that is useful for the response 216A.

The computing device 203 can receive the response 216A and can render the response 216A on a display. The user can provide an input 213B to the computing device 203. The computing device 203 can transmit the input 213B to the contextual response system 201B via the URL associated with the first container 219A. The input 213B can include “Where can I find Twins gear?” The NLP service 205B can process the input 213B and can associate the input 213B with a “Merchandise” context 214B. The NLP service 205B can process the input 213B based on the context 214B to generate an intent 215B. The intent 215B can include a desire to access information for one or more physical or digital merchandise vendors. The intent 215B can include a naming convention “merchandise:vendor_locations-learn.” The naming convention can include a modifier based on a determination that the computing device 203 is, or will be, physically present at the venue. The modifier can cause the contextual response system 201B to filter the subsequent response to include only physical locations, only digital locations, or to include both physical and digital locations.

The response service 207B can process the context 214B and the intent 215B to generate a response 216B. The response 216B can include natural language, such as “Sweet! Get all the freshest Twins gear!” The response 216B can include a selectable link for an online merchandise sales platform. The contextual response system 201B can transmit the response 216B to the computing device 203. The computing device 203 renders the response 216B on the display.

Referring now to FIG. 2, illustrated is a network environment 200 in which an embodiment of the contextual response system 201 can operate. The computing environment 200 can include the contextual response system 201 and one or more computing devices 203. In some embodiments, the computing environment 200 includes one or more external services 226. The contextual response system 201 can communicate with the computing device 203 and the external service 226 via one or more networks 202. The network 202 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks. The contextual response system 201 can communicate with a first computing device 203 over a first network 202 and communicate with a second computing device 203, or external service 226, over a second network 202.

As shown and described herein, the contextual response system 201 can process a natural language input from the computing device 203 and generate a natural language output for responding to the natural language input. The contextual response system 201 can include, but is not limited to, a communication service 204, the natural language processing (NLP) service 205, a response service 207, the LLM service 208, a rules service 209, and one or more data stores 211. The contextual response system 201 includes, for example, a Software as a Service (SaaS) system, a server computer, or any other system providing computing capability. Alternatively, the contextual response system 201 may employ computing devices that may be arranged, for example, in one or more server banks or computer banks or other arrangements. Such computing devices can be located in a single installation or may be distributed among many different geographical locations. For example, the contextual response system 201 can include computing devices that together may include a hosted computing resource, a grid computing resource, and/or any other distributed computing arrangement. In some cases, the contextual response system 201 can correspond to an elastic computing resource where the allotted capacity of processing, network, storage, or other computing-related resources may vary over time. In various embodiments, the contextual response system 201 (e.g., or one or more elements thereof) may be embodied as a browser feature, a browser plug-in, a browser web extension, an application, or a live chat bot launched on a particular website or network platform.

As further shown and described herein, the NLP service 205 can process an input 213 and associate the input 213 with one or more contexts 214, intents 215, and metrics for categorizing, rating, or classifying the input 213, such as a level of granularity. The response service 207 can generate a response 216 to the input 213 based on the one or more contexts 214, intents 215, and/or other metrics. The LLM service 208 can augment the processes performed by the communication service 204, the NLP service 205, the response service 207, the rules service 209, and/or any other particular service of the contextual response system 201. For example, the LLM service 208 can be used by any service of the contextual response system 201 to identify contexts 214, identify intents 215, generate responses 216, and/or process any particular information. The rules service 209 can format the response 216 (e.g., or a communication including the response 216) based on an intended recipient thereof and/or a means or mode of communication by which the response 216 will be transmitted (e.g., SMS text, instant message on a particular platform, electronic mail, etc.). Various applications and/or other functionality may be executed in the contextual response system 201 according to various embodiments. In various alternate embodiments, one or more elements of the contextual response system 201 are external services 226.

Various data is stored in the data store 211 that is accessible to the contextual response system 201. In some embodiments, the data store 211, or a subset of data stored thereat, is accessible to the computing device 203. In various embodiments, subsets of data stored at the data store 211 is accessible via containers 219 (e.g., as shown in described herein). The container 219 may embody a standalone instance of a contextual response system 201 (e.g., an entity and/or context-specific instance of the contextual response system 201). The data store 211 can be representative of a plurality of data stores 211 as can be appreciated. The data stored in the data store 211, for example, can be associated with the operation of the various applications and/or functional entities described herein. The data store 211 can include, but is not limited to, knowledge bases 212, inputs 213, contexts 214, intents 215, responses 216, user accounts 217, and models 220.

The knowledge base 212 can include data for processing, analyzing, and responding to inputs 213 (e.g., a conversational input received from a computing device 203). The knowledge base 212 can include information for identifying verbs, nouns, and other parts of speech, and relationships therebetween. The knowledge base 212 can include one or more corpuses of information for determining one or more contexts 214 and/or intents 215 of an input 213. The knowledge base 212 can include associations with one or more contexts 214, intents 215, and/or additional metrics. The knowledge base 212 can include, for example, one or more corpuses of keywords, key phrases, and associations the keywords and key phrases with one or more contexts 214, one or more intents 215, and/or levels of granularity. In one example, a knowledge base 212 is associated with a “ticketing” context 214 and includes keywords including, but not limited to, “ticket,” “pass,” “tix,” “permit,” “stub,” “ticket price,” “reservation,” and “entry code.” The knowledge base 212 can include any suitable number of keywords, key phrases, language structures, and/or language patterns with which an input 213 may be associated. In one example, a knowledge base 212 can be associated with a “food and beverage” context 214 and can include hundreds or millions of keywords and key phrases associated with drinking-related activities, eating-related activities, food names, beverage names, names of food and beverage providers, food quantities, beverage quantities, and combinations thereof.

In one example, each of a plurality of contexts 214 can be associated with a different knowledge base 212, and each knowledge base 212 can include a different set of keywords. Continuing this example, the NLP service 205 can process an input 213 and identify a top-ranked knowledge base 212 based on a greatest number of keyword matches. In the same example, the NLP service 205 may associate the input 213 with one of the plurality of contexts 214 with which the matched knowledge base 212 is associated.

In another example, a knowledge base 212 can include a plurality of keyword sets, and each of the plurality of keywords is associated with a different intent 215. Continuing this example, the NLP service 205 can process an input 213 and identify a top-ranked keyword set based on a greatest number of keyword matches. In the same example, the NLP service 205 can associate the input 213 with the intent 215 corresponding to the top-ranked keyword set.

The knowledge base 212 can include grammatically and/or typographically flawed permutations of natural language (e.g., inclusive of colloquial terms, slang terms, and abbreviations of terms). For example, a knowledge base 212 includes “tickets” and abbreviations and misspellings thereof including, but not limited to, “tix,” “tickats,” “tocket,” “ticks,” “tcks,” “tkts,” and “ticket.” The NLP service 205 can update the knowledge base 212 include additional permutations of natural language (e.g., based on historical inputs 213, information from one or more external services 226, or information from other knowledge bases 212).

The knowledge base 212 can include one or more knowledge volumes. The knowledge volume can include data for processing, analyzing, and responding to inputs 213. The knowledge volume can include data associated with a particular context 214 and/or intent 215. For example, a first knowledge volume and a second knowledge volume may each be associated with a “ticketing” context 214. The first knowledge volume may include a first corpus of keywords associated with a “buy ticket” intent 215 and the second knowledge volume may include a second corpus of keywords associated with an “access ticket information” intent 215.

The knowledge base 212 can be generated based on a particular entity for which an instance of the contextual response system 201 is implemented. In one example, the entity is a zoo operator and a corresponding knowledge base 212 includes keywords associated with a corresponding zoo, such as zoo name, nickname, seasonal events, ticket types, special events, accommodations, vendor names, animal and other creature names, parking terms, local or regional directional information, and terms associated with points of interest within and around the zoo. In another example, the entity is a sports franchise and a corresponding knowledge base 212 includes keywords and phrases related to game schedules, ticket pricing and availability, adverse weather conditions, and season ticket holder support. The contextual response system 201 can receive one or more criteria associated with the particular entity and generate the knowledge base 212 based thereon (e.g., by obtaining one or more knowledge volumes corresponding to the one or more criteria).

The knowledge base 212 can include data specific to the entity employing the contextual response system 201. The knowledge base 212 can include all publicly available data associated with the entity employing the contextual response system 201. For example, the contextual response system 201 can extract from the external services 226 (e.g., the official website of the Atlanta Braves) the official bag policy of the Atlanta Braves. The knowledge base 212 can include all privately available data associated with the entity employing the contextual response system 201. For example, the external services 226 of the entity can send one or more recordings made of telephonic conversations made between a patron (e.g., user, customer, client, attendee, etc.) and one or more live agent handler(s) 307. The contextual response system 201 can request public and/or private data associated with the entity at any particular interval in time (e.g., once a day, once a month, once a year, etc.). The NLP service 205 can associate the data specific to the particular entity to one or more knowledge volumes. For example, the NLP service 205 can associate the bag policy extracted from the website of the Atlanta Braves with a venue policy knowledge volume.

The knowledge base 212 can include a vector database. The vector database can include data that is indexed with a corresponding embedded vector. For example, each word processed through the contextual response system 201 can include an embedded vector. Further continuing this example, the embedded vector can provide a numerical representation of the particular word in a multi-dimensional space. By generating embedded vectors for each word processed by the contextual response system 201, the contextual response system 201 can compare words based on their corresponding embedded vectors. The contextual response system 201 can employ the K-Nearest Neighbors Algorithm, and/or any other classification algorithm, to identify similarities in data based on the embedded vectors. For example, the contextual response system 201 can compare the two or more words by using the K-Nearest Neighbors Algorithm to calculate the mathematical proximity between the embedded vectors (e.g., their proximity in the multi-dimensional space). The contextual response system 201 can identify words that are semantically similar (e.g., “venue” and “stadium”) by calculating and identifying the relatively small distance between the two or more corresponding embedded vectors in the multi-dimensional space. The contextual response system 201 can identify words that are semantically distinct (e.g., “hotdog” and “baseball”) by calculating and identifying the relatively large distance between the two or more corresponding embedded vectors in the multi-dimensional space.

The vector database can include embedded vector for any of the particular data stored in the data store 211. The vector database can include embedded vectors for all of the inputs 213, all of the contexts 214, all of the intents 215, all of the responses 216, and all of the knowledge bases 212. For example, the vector database can include indexed embedded vectors for each of the knowledge volumes stored in the knowledge base 212. In another example, the vector database can include embedded vectors for each of the contexts 214. In yet another example, the vector database can include embedded vectors for each of the keyword sets associated with one or more intents 215 and/or one or more contexts 214. In yet another example, the vector database can include embedded vectors that each correspond to a phrase and/or a combination of words (e.g., more than one word). The vector database can be partitioned to separate the embedded vectors associated with each particular entity using the contextual response system 201. The vector database can be associated amongst organizations that share similar features. For example, a first vector database with embedded vectors generated based on information processed and generated for the Miami Marlins can be linked to a second vector database with embedded vectors generated based on the information processed and generated for the Atlanta Braves.

A plurality of knowledge volumes can be assigned a respective level of information scope. The knowledge volumes can be ordered into a plurality of knowledge tiers based on corresponding assignments of information scope. For example, a knowledge tier can include a plurality of knowledge volumes arranged by decreasing level of information scope assignment. For example, a knowledge base 212 may include a tiered or hierarchical structure including, by decreasing level of information scope assignment, a global knowledge tier, a vertical knowledge tier, a sub-vertical knowledge tier, and a local knowledge tier.

The knowledge base 212 can be associated with one or more contexts 214. For example, a first knowledge base 212 may be associated with a first context 214 “Ticketing at Madison Square Garden,” a second knowledge base 212 may be associated with a second context 214 “Food and Beverage Services at Madison Square Garden,” and a third knowledge base 212 may be associated with a third context 214 “Health and Safety Services at Madison Square Garden.” In this example, “Madison Square Garden” may be a fourth context 214 with which the first, second, and third knowledge bases 212 are associated (e.g., the fourth context 214 being associated with a broader scope of information versus the more specific scope of the first, second, and third contexts 214).

The knowledge base 212 can be associated with one or more contexts 214. For example, the knowledge base 212 can be associated with a first context 214, “Ticket Sales,” a second context 214, “Parking,” a third context 214, “Ticket Services,” a fourth context 214, “Season Tickets,” a fifth context 214, “Food and Beverage Services,” a sixth context 214, “Venue Services,” a seventh context 214, “Event Services,” an eighth context 214, “Media Services,” and a ninth context 214 “Personnel Services.”

The knowledge base 212 can include a plurality of knowledge tiers including, but not limited to, a global knowledge tier, a vertical knowledge tier, a sub-vertical knowledge tier, and a local knowledge tier. The plurality of knowledge tiers can each be assigned a level of information scope. The plurality of knowledge tiers can be organized in descending order based on the level of information scope. The global knowledge tier can be assigned to a first level of information scope, the vertical knowledge tier can be assigned to a second level of information scope that is less than the first level. The sub-vertical knowledge tier can be assigned to a third level of information scope that is less than the second level. The local knowledge tier can be assigned to a fourth level of information scope that is less than the third level. In some embodiments, the assigned level of information scope corresponds to a level of granularity of the information included in the one or more knowledge volumes from which the plurality of tiers may be derived. A greater level of assigned information scope can correspond to a lower level of granularity.

In an example scenario, a knowledge volume includes a first list including member states of the United Nations, a second list including states and provinces of each of the member states, a third list including cities of the states and provinces of each of the member states, and a fourth list including public transportation keywords (e.g., destinations, pass names, etc.) for each of the cities of the third list. The first list may be associated with a lowest level of granularity and may be assigned to a first level of information scope. The second list may be associated with a low level of granularity and may be assigned to a second level of information scope (e.g., less than the first level). The third list may be associated with a medium level of granularity and may be assigned to a third level of information scope (e.g., less than the second level). The fourth list may be associated with a high level of granularity and may be assigned to a fourth level of information scope (e.g., less than the third level). The lists may be incorporated into a plurality of knowledge tiers based on their assigned level of information scope. A global knowledge tier may include the first list, a vertical knowledge tier may include the second list, a sub-vertical knowledge tier may include the third list, and a local knowledge tier may include the fourth list.

Two or more knowledge volumes may be incorporated into the same or different knowledge tiers. As an example of the former, a knowledge base 212 may be associated with a “Parking” context 214 and include a plurality of knowledge tiers. A first knowledge volume may include keywords and phrases related to parking activities at a baseball stadium and a second knowledge volume may include keywords and phrases related to parking activities at an art museum. The plurality of knowledge tiers may include a vertical knowledge tier that includes both the first and second knowledge volumes.

As an example of the latter, a knowledge base 212 may be associated with a “Parking” context 214 and include a plurality of knowledge tiers. The first knowledge volume may include keywords and phrases associated with parking locations of a baseball stadium and a second knowledge volume may include keywords and phrases associated with parking fares and operating hours of the parking locations. The plurality of knowledge tiers may include a vertical knowledge tier that includes the first knowledge volume and a sub-vertical knowledge tier that includes the second knowledge volume.

As another example, a knowledge volume may be associated with a “Food and Beverage” context 214 and include a first subset, a second subset, a third subset, and a fourth subset (e.g., the subsets being mutually exclusive in some embodiments and, in other embodiments, not). The first subset may include keywords and phrases for all foods and beverages offered at a particular venue. The second subset may include keywords and phrases for prices of the foods and beverages at the particular venue. The third subset may include keywords and phrases related to a mapping of the foods and beverages to individual merchants at the particular venue. The fourth subset may include keywords and phrases related to availability of each of the foods and beverages at the corresponding merchant (e.g., capacity, operating hours, wait time, etc.). The knowledge volume may be segmented out into a plurality of knowledge tiers including a global knowledge tier, a vertical knowledge tier, a sub-vertical knowledge tier, and a local knowledge tier. The global knowledge tier may include the first subset, the vertical knowledge tier may include the second subset, the sub-vertical knowledge tier may include the third subset, and the local knowledge tier may include the fourth subset.

The knowledge base 212 can include past conversations performed between the contextual response system 201 and one or more computing devices 203. The past conversations can include all inputs 213 and corresponding responses 216. For example, the knowledge base 212 can include one or more conversations performed by the contextual response system 201 answering questions regarding exchanging tickets for new tickets on a different date. The knowledge base 212 can store previous identified contexts 214 and previous identified intents 215 such that the contextual response system 201 can select previously identified contexts 214 and previous identified intents 215 on receiving previously presented inputs 213.

The inputs 213 can include natural language, such as text strings. The inputs 213 may include conversational inputs as shown and described herein. The inputs 213 can include transmissions from the computing device 203, such as, for example, requests for services, information, or other functions. The inputs 213 can include time-series sequences of conversational inputs (e.g., representing a conversation between a user and the contextual response system 201). The stored inputs 213 can include indications of associated context(s) 214, intent(s) 215, response(s) 216, user account 217, container(s) 219, and/or model(s) 220. For example, a particular input 213 can include a natural language text string, which is sent by the computing device 203 through the container 219 and received by the contextual response system 201. The input 213 can include metadata including, but not limited to, timestamp receipt, device identifying information (e.g., IP address, MAC address, device identifiers, etc.), user identifying information (e.g., username and other credentials, mobile service provider, etc.), geolocation information (e.g., GPS data, cell tower data, etc.), and media files (e.g., audio recordings, images, videos, etc.). In one example, the input 213 includes an audio file and a natural text string extracted from the audio file (e.g., via processing the NLP service 205 processing the input 213 via one or more NLP algorithms). In some embodiments, the contextual response system 201 omits or deletes personal identifiable information (PII) from a conversational input (or sequence thereof) prior to storing the conversational input as the input 213. In one example, the contextual response system 201 processes a conversational input to remove personal names, addresses, and transactional information therefrom before storing the conversational input at the data store 211.

The context 214 can be a set of computing resources for responding to one or more inputs 213 of a particular type or subject. The context 214 can include associations between the context 214 and one or more knowledge bases 212, intents 215, responses 216, models 220, and external services 226. For example, a first context 214 may be “Food and Beverages at Yankee Stadium” and may be associated with a first set of resources including a first knowledge base 212, a first set of intents 215, a first set of responses 216, and a first model 220. In the same example, a second context 214 may be “Parking and Transportation at Yankee Stadium” and may be associated with a second set of resources including a second knowledge base 212, a second set of intents 215, a second set of responses 216, and a second model 220.

The NLP service 205 can determine an association between the input 213 and one or more contexts 214 based on one or more factors including, but not limited to, a container 219 by which an input 213 is received and natural language of the input 213. The context 214 may include labels of particular topics, subjects, tasks, and services with which the input 213 may be associated. For example, a first context 214 may be “Parking,” a second context 214 may be “Ticketing,” and a third context 214 may be “VIP Services.” The context 214 can be associated with a particular entity, such as a particular venue, franchise, or location. For example, a first context 214 may be “Parking at Venue X,” a second context 214 may be “Ticketing at Venue X,” and a third context 214 may be “VIP Services at Location Y.” In this example, the first and second context may be associated with a first entity, Venue X, and the third context 214 may be associated with a second entity, location Y. In some embodiments, the context 214 is associated with multiple entities, such as multiple locations or instances of a franchise. For example, the context 214 may be a “Food and Beverage” context and may be associated with multiple locations of Six Flags Theme Parks.

In some embodiments, the context 214 includes one or more corpuses of natural language linked to the context 214. In at least one embodiment, the NLP service 205 compares the input 213 to the one or more corpuses to generate a similarity score (e.g., via any suitable method, such as vectorization and distance metrics). The NLP service 205 may determine that the similarity score satisfies a predetermined threshold (e.g., and/or that the input 213 matches a threshold-satisfying number of terms in the one or more corpuses). The NLP service 205 can assign the input 213 to the context 214 in response to determining the similarity score satisfies a predetermined threshold. In some embodiments, the NLP service 205 assigns the input 213 to one or more top-ranked contexts 214 from a plurality of contexts 214. The NLP service 205 can perform context association processes in a rank-ordered manner such that the NLP service 205 first determines if an input 213 is associated with a top-ranked context 214 and, if not, proceeds to sequentially determine whether the input 213 is associated with a second-ranked context 214 or other, lower-ranked contexts 214. The NLP service 205 can generate, retrieve, and update rankings of contexts 214 (e.g., based on a particular entity associated therewith, previous context associations, and other historical data).

The intent 215 can be a desired action and/or desired information. The intent 215 can be associated with a context 214. For example, an intent 215 may be a desire to access operating hours of “Zoo Y.” In this example, the associated context 214 may be “Ticketing at Zoo Y.” In various embodiments, multiple intents 215 may be associated with the same context 214 and differing actions or desired information. For example, a first intent 215 and second intent 215 may be associated with a “Food and Beverage” context 214. In this example, the first intent 215 may be associated with “Price of a Hotdog,” and the second intent 215 may be associated with “Price of a Beer.” In the same example, a third intent 215 may be associated with “Price of Combo #1, Beer and Hotdog.” In one or more embodiments, multiple intents 215 may be associated with the same context 214 and with similar actions or desired information.

In at least one embodiments, intents 215 may demonstrate varying levels of granularity. For example, a first intent 215 and a second intent 215 may be associated with a “Beverages at Busch Stadium” context 214. In the same example, the first intent 215 may be associated with accessing beverage information at a first level of granularity to identify any location inside the stadium at which beverages may be purchased. Continuing the example, the second intent 215 may be associated with accessing beverage information at a second level of granularity to identify locations inside the stadium at which liquor beverages may be purchased. The data store 211 can include associations between intents 215 and responses 216. For example, the data store 211 can include decision-tree data structures for indicating associations between intents 215 and responses 216 (e.g., the intents 215 and responses 216 also sharing a contextual association). In other words, the intent 215 of the input 213 and an intent-associated response 216 may embody a question-answer relation (e.g., which may be further influenced by determined the granularity of the input 213 for which the intent 215 is determined).

The intent 215 can include a naming convention. The name of the intent 215 can be a concatenation of data classes associated with which the intent 215 is associated. The data classes may include, but are not limited to, context 214, topics, subtopics, modifiers, and actions. In some embodiments, granularity levels described herein include topics, subtopics, modifiers, and/or actions. For example, the contextual response system 201 may determine an association between an input 213 and intent 215 based at least in part on a determination that the input 213 is associated with one or more topics, subtopics, modifiers, and/or actions. In this example, the contextual response system 201 may determine a level of granularity based at least in part on the associations of the input 213 with the one or more topics, subtopics, modifiers and/or actions.

As shown in Table 1, the naming convention may include a concatenation of the form “Context: Topic-Subtopic-Modifier-Action.” Table 1 presents an example naming convention in the context of ticketing services for a ski lodge. The naming convention can identify one or more contexts 214 with which an intent 215 is associated. The naming convention can include one or more topics within the context. The naming convention can include a modifier for indicating a class or subject with which an instance of a topic is associated. For example, in Table 1, the modifier “ikon” may refer to an annual ski pass and the modifier “kids” may refer to tickets for a child subject.

The naming convention can include an action that indicates desired object or action of the intent 215. The “learn” action can indicate a desire for information regarding a topic and/or subtopic. For example, the action “learn” in row 2 of Table 1 may indicate a desire obtain information regarding when an annual pass at Ikon ski resorts are available for purchase. As another example, the action “buy” in row 5 of Table 1 may indicate a desire to purchase a kid's ski resort ticket at a discounted price. Additional examples of actions include, but are not limited to, cancel, stop, reschedule, repeat, combine, reduce, increase, access, and block.

TABLE 1
Example Intent Naming Conventions

| | | | | | | Human Readable |
|---|---|---|---|---|---|---|
| Context | Topic | Sub-topic | Modifier | Action | Intent Name | Name |
| tickets | annual_pass | on_sale_date | ikon | learn | tickets: annual_pass- | Learn About Ikon |
| | | | | | on_sale_date-ikon- | Annual Pass On |
| | | | | | learn | Sale Date |
| tickets | annual_pass | policy | ikon | learn | tickets: annual_pass- | Learn About Ikon |
| | | | | | policy-ikon-learn | Annual Pass Policy |
| tickets | annual_pass | price | ikon | learn | tickets: annual_pass- | Learn About Ikon |
| | | | | | price-ikon-learn | Annual Pass Price |
| tickets | tickets | discount | kids | buy | tickets: tickets- | Buy Kids Tickets |
| | | | | | discount-kids-buy | Discount |
| tickets | tickets | discount | kids | learn | tickets: tickets- | Learn About Kids |
| | | | | | discount-kids-learn | Tickets Discount |

The responses 216 can include data for replying to the inputs 213. The responses 216 can include natural language entries, such as text strings. For example, an input 213 may include “where is the parking lot” and the NLP service 205 may associate the input 213 with a container 219 “Yankees,” a context 214 “parking” and an intent 215 “access parking lot address.” In this example, a response 216 may include “1187 River Ave, The Bronx, NY 10452.” The responses 216 may include media files, such as images, videos, or audio recordings. For example, the response 216 may include an image of a map for navigating to or within a particular location. In another example, the response 216 may include an image of a person-of-interest, such as an athlete, musical artist, or public speaker. In another example, the response 216 may include images, recordings, and/or videos of an animal.

The response 216 may include selectable links that, upon selection at the computing device 203, cause the computing device 203 to access a particular networking address and display content hosted thereat. The response 216 may include tables, such as, for example, a table of ticket types and prices, a table of potential dates for scheduling an activity, or a roster of a sports team. The response 216 may include a selectable link that, upon selection, causes the computing device 203 to load a particular application, such as a navigation application, media streaming application, or social media application. The response 216 can include requests for collecting data from the computing device 203. For example, the response 216 can include a request for collecting geolocation data of the computing device 203. In another example, the response 216 can include a request for capturing an image, video, or audio recording via the computing device 203. In another example, the response 216 can include a request for transaction processing information (e.g., or a link to an online transaction processing environment).

The response 216 can include a call to one or more external services 226 such that, when the response 216 is identified for replying to the input 213, the contextual response system 201 performs one or more calls to request and obtain data from an external service 226. In one example, an input 213 may include “how much is gas in Brookhaven” and may be associated with a context 214 “Costco.” In this example, a response 216 may include a call to an external service 226 for accessing current Costco gas prices. Continuing the example, the contextual response system 201 may call the external service 226 (e.g., the call including an indication of the location, Brookhaven) and, in response, receive a current gas price for a Brookhaven Costco location. In another example, the response 216 includes a call to a weather forecasting service. In another example, the response 216 includes a call to a social media platform, or a particular account thereof.

The response 216 can include an association between the response 216 and one or more models 220, such as, for example, decision trees. The response 216 can include conditional variables that may be used based on the computing device 203 from which an input 213 was received. The response 216 can include conditional variables that may be used based on a user account 217 with which the input 213 or computing device 203 is associated. For example, the response 216 may include conditional variables for gender pronouns such that the contextual response system 201 formats the response 216 based on a gender identity of the user account 217. In another example, the response 216 may include conditional variables for an operating system of the computing device 203 such that the contextual response system 201 formats the response 216 based thereon. In another example, the response 216 may include conditional variables for an age of the user such that the contextual response system 201 restricts the response 216 based thereon (e.g., preventing an underage user from accessing controlled substance information, adult-only sections of a venue, etc.).

The response 216 can include one or more dynamic content variables. The dynamic content variable can be a variable with one or more configurable elements. The response service 207 can determine the value of the dynamic content variable based on a container 219 by which the response 216 is to be transmitted. The response service 207 value of the dynamic content variable based on a context 214 or intent 215 with which the response 216 is associated. The response service 207 may determine the value of the dynamic content variable by requesting data from one or more external services 226. The response service 207 and/or the rules service 209 may update the response 216 based on the dynamic content variable. Updating the response 216 can include, but is not limited to, adjusting the composition of the response 216 (e.g., inserting one or more text strings into the response 216, populating dynamic content variables with text string-formatted data, etc.), modifying one or more visual elements of the response 216, or modifying one or more visual elements of a container 219 or (e.g., including a visual appearance of a user session with which the container 219 is associated).

In one example, a response 216 can include ticket information and a dynamic content variable of the response 216 can include a current price of the ticket. The response service 207 can generate the current price of the ticket by processing the dynamic content variable based on a container 219 and/or context 214 with which the response 216 is associated. The response service 207 can retrieve the current price of the ticket from the data store 211 or request and receive the current price of the ticket from an external service 226 (e.g., via an application programming interface (API) interaction, such as a remote procedure call).

In another example, a dynamic content variable includes a current beer price. The response service 207 can generate the current beer price by processing the dynamic content variable based on an associated container 219, context 214, intent 215, and/or level of granularity. In a particular container 219, the NLP service 205 can determine that a first input 213 “how much for a beer?” is associated with a “Beverages” context 214, a first “learn beer price” intent 215 (e.g., “beverages: beer-currenprice-learn”), and a first level of granularity. The response service 207 can generate a response 216 that includes a dynamic content variable, or plurality thereof, for the current price of beers associated with the particular container 219. The response service 207 can generate, or receive from an external service 226, a current price of each of a plurality of beers associated with the container 219. The response service 207 can update the value of the dynamic content variable(s) based on the current price of each of the plurality of beers. In the particular container 219, the NLP service 205 can determine that a second input 213 “how much for an IPA?” is associated with the “Beverages” context 214, a second “learn beer price” intent 215 (e.g., “beverages: beer-IPA-currentprice-learn”), and a second level of granularity, greater than the first level of granularity. The response service 207 can generate a response 216 that includes a dynamic content variable for the current price of an IPA beer associated with the particular container 219. The response service 207 can generate, or receive from an external service 226, a current price of the IPA beer and modify a response 216 to include the current price.

The responses 216 can include one or more responses 216 generated by the LLM service 208. The NLP service 205 can call the LLM service 208 to generate the response 216 to the particular input 213 received from the computing device 203. The NLP service 205 can generate a first response 216 and employ the LLM service 208 to generate a second response 216. The NLP service 205 can generate a quality score to determine the best response 216 for the particular input 213. For example, contextual response system 201 can receive the input 213, “Where is parking lot C.” Continuing this example, the NLP service 205 can generate the first response 216 that states, “Parking lot C is located off of exit 54 of interstate I-285.” Further continuing this example, the LLM service can generate the second response 216 that states, “If approaching the stadium from the west take exit 54 of interstate I-285; if approaching the stadium from the east, continue straight on Random Street NE until reaching Lot C on your right hand side at 332 Random Street NE, Atlanta GA, 30326.” The NLP service 205 can generate the quality score by averaging various metrics (e.g., number of words, detail, length of words, sentence length, etc.) of the first response 216 and the second response 216.

The responses 216 can be associated with one of a plurality of response tracks including, but not limited to, a main response track, a fallback response track, and a base response track. The main response track can include responses 216 that are entity-specific, location-specific, or specific to a subset of an entity. The fallback response track can be specific to a category of entities, or, if an entity includes various subsets, an overall entity. The base response track can include one or more default responses 216 for replying to inputs 213 for which a response 216 cannot be identified within the main response track or the fallback response track.

In one example, the entity is a particular food vendor. For a “Health and Nutrition” context 214, a main response track may include, but is not limited to, allergen data and nutritional data of each food product offered by the particular food vendor. A fallback response track may include, but is not limited to, allergen data and nutritional data from other food vendors or from one or more external services 226 (e.g., U.S. Department of Agriculture, Nutritionix, etc.). A default response track may include generic responses, such as “I am not sure,” “I cannot find an answer at this time, but I will notify you when I do,” or “I cannot verify that [input-requested food product] does not include [x], [y], and/or [z] allergen(s).”

In another example, the entity is a particular Major League Baseball (MLB) team. For a “Scheduling” context 214, a main response track may include a regular season schedule of the particular MLB team as sourced from a front office of the particular MLB team. A fallback response track may include a league-wide regular season schedule as provided by the overall MLB organization and/or regular season schedules from other MLB teams. A base response track may include one or more generic responses, such as “Sorry, I am unable to answer that” or “I do not have an answer at this time, would you like to be notified when I find an answer?”

The responses 216 of each response track may be arranged by order of decreasing granularity. For example, a “Food Services” context 214 may be associated with one of a plurality of main response tracks (e.g., each main response track being associated with a different intent 215, or set thereof). The main response track may be associated with an intent 215 of “access spicy food location.” The main response track may include a first response 216 associated with a highest level of granularity and including a name and location of a particular food vendor considered to offer the spiciest food at a given venue. The main response track may include a second response 216 associated with a medium level of granularity and including names and locations of a plurality of food vendors considered to offer at least one spicy food item at the given venue. The main response track may include a third response 216 associated with a low level of granularity and including names and locations of all food vendors at the given menu.

In another example, the NLP service 205 can employ the LLM service 208 to generate the main response track, the fallback response track, and the base response track. For example, the NLP service 205 can provide the LLM service 208 one or more knowledge bases 212 to act as sources of information for generating the response 216 to the input 213. For example, the knowledge bases 212 can include all current policy documents of the particular entity employing the contextual response system 201. The LLM service 208 can output the main response track by generating one or more statements based on the knowledge bases 212 and in response to the input 213. The LLM service 208 can generate the fallback response track by augmenting excerpts from the knowledge bases 212 with generated statements. The LLM service 208 can generate the base response track by directly quoting information found in the knowledge bases 212 and without adding any additional details to the response 216 to the input 213.

The response service 207 can scan through the main response track and the fallback response track to identify a response 216 for responding to an input 213 (e.g., based on the context 214, intent(s) 215, and/or other metrics associated therewith). The response service 207 may attempt to identify the response 216 by scanning through the main response track and the fallback response track in a serpentine manner. For example, when iterating through response tracks to identify a suitable response 216, the response service 207 may first consider a highest granularity response in the main response track. In response to determining that the highest granularity response in the main response track is unavailable or unsuitable, the response service 207 may then consider a highest granularity response in the fallback response track. In response to determining that the highest granularity response in the fallback response track is unavailable or unsuitable, the response service 207 may return to the main response track and consider a second-highest granularity response therein. In response to determining that the second-highest granularity response of the main response track is unavailable or unsuitable, the response service 207 may return to the fallback response track and consider a second-highest granularity response therein (e.g., and so on and so forth until a suitable response is identified). In response to failing to identify a suitable response in both the main response track and the fallback response track, the response service 207 may access a generic response in an associated base response track, such as “I cannot find an answer at this time,” “I am not sure about that one, would you like to be notified when I have an answer?,” or “I am having trouble finding an answer, can I connect you to a live agent?”

The user account 217 can include user credentials (e.g., name, username, password, biometric data, etc.), a user identifier, a device identifier, contact information, user preferences, or other identifying information. The user identifier can correspond to an identifier stored in one or more external services 226, such as, for example, a user identifier in a ticketing system, a user identifier in a social media platform, or a user identifier in a transaction system. In some embodiments, in response to receiving a transmission from the computing device 203, the communication service 204 identifies a corresponding user account 217 based on the transmission. In at least one embodiment, the communication service 204 enforces a login or authentication operation to initiate functions described herein. The communication service 204 can prompt the computing device 203 (e.g., or user thereof) to provide credential data, such as a username, password, and/or dual-authentication input (e.g., one-time code, biometric data, etc.). The communication service 204 can authenticate the credential data to allow access to functions described herein (e.g., contextual response generation processes described herein). The communication service 204 can store user sessions at the data store 211. The stored user session can include, but is not limited to, inputs 213, responses 216, and any metrics with which the user session is associated. The user account 217 can include one or more subscriber lists and/or an association of the user account with one or more subscriber lists. The subscriber list can correspond to a list of recipients for communications related to a particular context 214, intent 215, or combination thereof. For example, in response to providing a default response 216 to an input 213 (e.g., a response that fails to address, or only partially addresses, the input 213), the response service 207 adds an input-associated user account 217 to a subscriber list with which the context 214 and the intent 215 of the input 213 is associated. Continuing this example, upon identifying an adequate (e.g., non-default) response 216 to the input 213, the response service 207 transmits the response 216 to each computing device 203 associated with each user profile 217 of the subscriber list.

The models 220 can include models for identifying and/or generating the responses 216. The model 220 can identify or generate the response by processing one or more of the input 213, the context(s) 214 of the input 213, the intent(s) 215 of the input 213, a level of granularity of the input 213, metadata of the input 213, a computing device 203 associated with the input 213, a user profile 217 associated with the input 213, a channel 218 by which the input 213 was received, and historical data including, but not limited, to historical inputs 213 and data associated therewith (e.g., historical contexts, intents, granularity levels, etc.), historical responses 216, and user interactions. The model 220 can include decision trees by which the response service 207 generates a response to an input 213. In various embodiments, a decision tree may include a type of supervised machine learning used to categorize or make predictions based on various conditions, including, but not limited to, context(s) 214, intent(s) 215, a level of granularity associated with an intent 215, one or more previous responses 216, and/or one or more previous inputs 213. The decision tree may be a form of supervised learning, meaning that the response service 207 may test and train the decision tree on a set of data that contains a pattern of sample natural language inputs and desired (and/or undesired) responses thereto. The model 220 can be associated with a particular response track, such as, for example, a main response track, a fallback response track, or a base response track.

The model 220 can include models for identifying a most appropriate response 216 to an input 213 based on or more of scoring, voting, and clustering. Non-limiting examples of such models include random forest classification, topic modelers, neural networks, linear regression, logistic regression, ordinary least squares regression, stepwise regression, multivariate adaptive regression splines, ridge regression, least-angle regression, locally estimated scatterplot smoothing, support vector machines, Bayesian algorithms, hierarchical clustering, k-nearest neighbors, K-means, expectation maximization, association rule learning algorithms, learning vector quantization, self-organizing map, locally weighted learning, least absolute shrinkage and selection operator, clastic net, feature selection, computer vision, dimensionality reduction algorithms, gradient boosting algorithms, and combinations thereof. Neural networks can include, but are not limited to, uni- or multilayer perceptron, convolutional neural networks, recurrent neural networks, long short-term memory networks, auto-encoders, deep Boltzman machines, deep belief networks, back-propagations, stochastic gradient descents, Hopfield networks, and radial basis function networks. A model 220 can be representative of a plurality of models of varying or differing composition and/or function.

The models 220 can include on or more Large Language Models (LLMs). The LLMs stored in the models 220 can include one or more proprietary natural language processing models, one or more third-party natural language processing models, and/or any particular natural language processing model. For example, the LLMs can employ one or more deep-learning models (e.g., transformer models, neural network models) to generate various responses 216, identify contexts 214, and/or identify intents 215. The LLMs can include third-party LLMs such as but not limited to ChatGPT (e.g., GPT-3, GPT-3.5, GPT-4), Bard, LaMDA, PaLM, and LLaMA.

The models 220 can include one or more embedding models, transformer models, and/or any other model to vectorize the data stored in the data store 211. Embedding models can function to generate embedded vectors for each data stored in the vector database of the knowledge base 212. Embedding models, for example, can generate embedded vectors for each of the inputs 213, each of the contexts 214, each of the intents 215, each of the responses 216, and/or a combination thereof. Embedding models can include but are not limited to Word2Vec, Glove, BERT, and any deep neural network or machine learning model for transforming words, sentences, or paragraphs into embedded vector equivalents. Similar embedding models can be used to transform images, videos, and audio into embedded vector equivalents.

The communication service 204 can receive and transmit data to and from the computing device 203 and the external service 226. The communication service 204 can receive requests from the computing device 203. The communication service 204 can process the request to generate or extract natural language inputs therein. In some embodiments, the communication service 204 processes the request to generate or retrieve metadata, as described herein. The communication service 204 can identify a source from which a request was transmitted, such as a particular computing device 203 or application 225 (e.g., or a particular channel 218, as shown and described herein). The communication service 204 can determine the user account 217 associated with the request (e.g., based on the source). In some embodiments, the communication service 204 causes the computing device 203, or a browser thereof, to access a particular URL and/or store cookie information for subsequent inclusion in a request, thereby providing a beaconing service for identifying the computing device 203.

The communication service 204 can request data from one or more external services 226 associated with the entity employing the contextual response system 201. For example, the communication service 204 can perform automated data scrapes to extract from the entity's website publically available documents (e.g., End User License Agreements (EULA), safety policies, inclement weather policies). In another example, the communication service 204 can request data from private data stores associated with the entity. The communication service 204 can request data at any particular time interval. For example, the communication service 204 can request data continuously, every hour, every day, every week, every month, every year, or any combination thereof.

The communication service 204 can include, but is not limited to, channels 218, containers 219, channel handlers 301, conversation managers 303, virtual assistant handlers 305, and live agent handlers 307. The accompanying description herein can provide additional details and aspects of the communication service 204 and example workflow thereof.

The channel 218 can be a medium or means by which the contextual response system 201 receives an input 213. Non-limiting examples of the channel 218 include web or browser-based messaging (e.g., respective channels 218 for entity-hosted websites, such as LinkedIn™ “, Shopify™, etc.), application-based messaging (e.g., respective channels 218 for WhatsApp™, Apple Business Chat™, Google™ Business Messages, Microsoft Teams™, etc.), SMS or other cellular text-based messaging, voice messaging (e.g., respective channels 218 for telephone, voice over internet, Amazon Alexa™, Google Assistant™, Siri™”, Bixby™, etc.), and social media-based messaging (e.g., respective channels 218 for Twitter™, Facebook Messenger™, Instagram Messenger™, etc.). The communication service 204 can include one or more channel handlers 301 for each channel 218. The channel handler 301 can receive inputs 213 and transmit responses 216 via the associated channel 218. In one example, a first channel 218 is associated with an online instant messaging service and a second channel 218 is associated with SMS text messaging. The communication service 204 can include a first channel handler 301 that receives inputs 213 and transmits responses 216 via the first channel 218 (e.g., in the form of instant messages) and a second channel handler 301 that receives inputs 213 and transmits responses 216 via the second channel 218 (e.g., in the form of SMS text messages).

The channel handler 301 can process an input 213 and identify a channel 218 associated therewith (e.g., an SMS channel, social media messaging channel, web-based channel, etc.). For example, the channel handler 301 can determine that an input 213 was received in the form of an SMS text message and, in response, associate the input 213 with an SMS text-based channel 218. The channel handler 301 can associate the input 213 with the particular channel 218, which may configure the communication service 204 to transmit responses 216 via the same channel 218 and cause the rules service 209 to format the response 216 to conform to the channel 218. As shown and described herein, the communication service 204 can relay a conversation from a first channel 218 to a second channel 218. In such instances, the channel handler 301 may dissociate corresponding input 213 from a first channel 218 and associate the input 213 with a second channel 218. For example, the communication service 204 may relay a conversation from a social media-based messaging channel to an SMS-based messaging channel.

The channel handler 301 can relay a conversation from a first channel 218 to a second channel 218. The channel handler 301 can relay the conversation based on one or more of an input 213, a change in container 219, a change in context 214, or a change in intent 215. In one example, via an instant messaging-based channel 218, the communication service 204 receives an input 213 that includes natural language of “please text me at 555-123-5689.” The NLP service 205 processes the natural language and associates the input 213 with an intent 215 of relaying a conversation from the instant messaging-based channel 218 to an SMS text-based channel 218. In response to the determination, the channel handler 301 causes the communication service 204 to transmit subsequent responses 216 via the SMS text-based channel 218 (e.g., and may cause the rules service 209 to format the subsequent responses 216 as SMS text messages).

The container 219 can include a set of resources for processing and responding to conversational inputs. The resources can include, but are not limited to, instances of the NLP service 205, the LLM service 208, the response service 207, and the data store 211 (e.g., or contents thereof, such as knowledge bases 212, contexts 214, intents 215, user accounts 217, channels 218, and/or models 220). The container 219 can be a standalone deployment of the contextual response system 201 with access to one or more processing resources, modules, or shared data structures of the contextual response system 201 (e.g., including the NLP service 205, response service 207, LLM service 208, rules service 209, and/or data store 211). The container 219 can include an instance of contextual response software programs embodying functionality shown and described herein. For purposes of description and illustration, operations of the container 219 are described in the context of the contextual response system 201. It may be understood and appreciated that the described functions of the contextual response system 201 may be individually embodied, on a context-specific basis, by one or more containers 219. Each container 219 can be associated with a different entity (e.g., where entities may or may not share traits). In some embodiments, the entity may be referred to as a client and customers or guests associated with the entity may be referred to as users. The entity can include, for example, an event or entertainment venue, a sports league, or franchise thereof, an amusement park, a zoo operator, an airport customer service, an airline customer service, or a tourism board. The container 219 can include indicia for visually identifying the container 219 and/or indicating affiliation of the container 219 with a particular entity, context 214, knowledge base 212, user account 217, or type of user account 217 (e.g., basic user, VIP user, etc.).

The communication service 204 can receive transmissions via each container 219. The container 219 can include an association with one or more contexts 214, knowledge bases 212, or user accounts 217. For example, a first container 219 may be associated with a first entity, Major League Baseball™, and a second container 219 may be associated with a second entity, the New York Yankees™. In another example, a first container 219 may be associated with a first context 214, “parking services,” and a second container 219 may be associated with a second context 214, “ticketing services.” In another example, a container 219 may be associated with a first context 214, “ticketing services,” and a second context 214, “food and beverages.” In one example scenario, a container 219 is associated with a theme park and a plurality of contexts 214 including ticketing services, food and beverages, health and safety, navigation, and loyalty programs.

The container 219 can be associated with one or more channels 218, such as, for example, a universal resource locator (URL) address, an inline frame (iframe), a particular server or port thereof, or a particular network 202. The container 219 can include a level of access or privilege with which a request (e.g., or a computing device 203 or user account 217) is associated. For example, a first container 219 may be associated with user accounts 217 having a basic privilege level and a second container 219 may be associated with user accounts having an administrator or VIP privilege level.

The conversation manager 303 can process an input 213 and identify a container 219 associated therewith. In some embodiments, the conversation manager 303 may be referred to as a “conductor.” The communication service 204 can receive an input 213 from a computing device 203, such as a request including one or more natural language strings. The conversation manager 303 can process the input 213 and determine that it was received via a particular URL address. The conversation manager 303 can associate the input 213 with a container 219 based on the particular URL address. As shown and described herein, the communication service 204 can relay a conversation from a first container 219 to a second container 219. In such instances, the conversation manager 303 may dissociate corresponding input 213 from a first container 219 and associate the input 213 with a second container 219. The conversation manager 303 can associate the input 213 with a container 219 based on the channel 218 by which the input 213 was received (e.g., which may be determined by the channel handler 301).

The conversation manager 303 can cause a change from a first container 219 to a second container 219. By changing containers, the communication service 204 may improve the quality of responses from the contextual response system 201 by utilizing a container 219 including one or knowledge bases 212 that are most closely associated with a context 214, intent 215, or granularity level of an input 213. The conversation manager 303 can cause a container change by relaying conversational input(s) from a first container 219 to a second container 219 (e.g., from a first instance of the contextual response system 201 to a second instance of the contextual response system 201, each instance being associated with different entities, knowledge bases 212, and/or contexts 214). To relay conversational input, the conversation manager 303 may provide one or more historical conversational inputs from the first container 219 to the second container 219. For example, the conversation manager 303 may transmit or forward conversational input(s) from processing resources of a first container 219 to processing resources of a second container 219. To relay conversational input from a first container 219 to a second container 219, a transition from a first instance of the contextual response system 201 to a second instance of the contextual response system 201 may occur (e.g., each instance being associated with a particular entity and/or context 214). The channel handler 301 may relay a conversation from a first channel 218 to a second channel 218 in response to, or as a part of, a relay of conversational input from a first container 219 to a second container 219.

In one example, a first container 219 is associated with an airline and a second container 219 is associated with a particular airport at which the airline operates flights. In this example, the conversation manager 303 may relay a sequence of conversational inputs from the first container 219 to the second container 219 in response to one of the sequence of conversational inputs, when processed, being associated with a context 214 for the particular airport and/or an intent 215 corresponding to the particular airport (e.g., a request for security wait times, a request for food and beverage information, a request for disability accommodations, etc.).

To relay a conversation between containers, the conversation manager 303 may command the computing device 203 or application 225 to switch from a first URL address for submitting conversational inputs to a second URL address for submitting conversational inputs. The conversation manager 303 may initiate an update to a user interface for receiving a conversational input. The conversation manager 303 may command the application 225 to update a user interface to replace a first set of indicia with a second set of indicia. The first set of indicia may be associated with a first context 214 and/or first entity, and the second set of indicia may be associated with a second context 214 and/or second entity.

In an example scenario, the communication service 204 receives a plurality of conversational inputs from a computing device 203 via a first container 219 associated with “National Football League.” The NLP service 205 processes the plurality of conversational inputs and determines a contextual change from a first context 214 “National Football League” associated with the first container 219 to a second context 214 “New England Patriots.” In response to the contextual change, the conversation manager 303 relays the plurality of conversational inputs, or a subsequent conversational input, to a second container 219 associated with the second context 214. In the above example, the first container 219 is associated with a first URL address and a first user interface, and the second container 219 is associated with a second URL address and a second user interface. The appearance of the first user interface may be based on branding of the “National Football League,” and the appearance of the second user interface may be based on branding of the “New England Patriots.” The relay of conversational input from a first container 219 to a second container 219 may the conversation manager 303 causing the computing device 203 to switch from a first instance of the application 225 to a second instance of the application 225 (e.g., each instance being associated with a particular entity and/or context 214).

The virtual assistant handler 305 can receive conversational inputs from the conversation manager 303 and provide the conversational inputs to the NLP service 205 for analysis. For example, the channel handler 301 receives an input 213 via a channel 218. The channel handler 301 provides the input 213 and an indication of the channel 218 to the conversation manager 303. Based on the input 213 and the indication of the channel 218, the conversation manager 303 associates the input 213 with a container 219. Based on the container 219, the conversation manager 303 transmits the input 213 to a virtual assistant handler 305 with which the container 219 is associated. Based on the container 219, the virtual assistant handler 305 provides the input 213 to an instance of the NLP service 205 with which the container 219 is associated.

The virtual assistant handler 305 can receive responses 216 from the response service 207 or the rules service 209. The virtual assistant handler 305 can provide the response 216 to the conversation manager 303 (e.g., which may provide the response 216 to a channel handler 301 for transmission to a computing device 203 via a channel 218). The virtual assistant handler 305 can receive user interaction data from the computing device 203 (e.g., via the channel handler 301 and the conversation manager 303). The user interaction data can include, but is not limited to, historical inputs 213, historical responses 216, actions initiated by the computing device 203 (e.g., selection of a link included in a response 216, completion of a transaction, etc.), navigation of the computing device 203 from a first location to one or more second locations, and user feedback (e.g., ratings, reviews, complaints, etc.). The virtual assistant handler 305 can store the user interaction data at the data store 211. The virtual assistant handler 305 can associate user interaction data with one or more user accounts 217 (e.g., the user interaction data being a potential input to future models 220 for identifying and/or formatting responses 216, or a potential to the NLP service 205 for improving context or intent determination).

The live agent handler 307 can transmit inputs 213 to and receive responses 216 from one or more live agents. A live agent can include a human operator. The live agent handler 307 can generate, maintain, and resolve support tickets. The support ticket may include an input 213 for which a response 216 could not be determined. The support ticket may identify one or more of a computing device 203 from which the input 213 was received, a channel 218 by which the input 213 was received, and a user account 217, container 219, context 214, and/or intent 215 with which the input 213 was associated. The support ticket may include an identifier generated by the communication service 204, which can be transmitted to the input-associated computing device 203 as a means of authentication or proof of authorization.

The NLP service 205 can process conversational inputs via one or more NLP algorithms and/or subservices to generate various outputs including, but not limited to, one or more contexts 214 of the conversational input, one or more intents 215 of the conversational inputs, one or more responses 216 to the conversational inputs, and a level of granularity of the conversational input. The NLP service 205 can execute different NLP algorithms and subservices for generating each output, as can be appreciated. The NLP service 205 may generate an output based at least in part on previously generated outputs. The NLP service 205 may determine a context 214 of a conversational input and determine an intent 215 of the conversational input based in part on the context 214. The NLP service 205 may determine a context 214 and an intent 215 of a first conversational input and determine an intent 215 of a second conversational input based on the context and intent of the first conversational input. The NLP service 205 can include one more machine learning models for processing the input 213 and associating the input 213 with one or more contexts 214, one or more intents 215, and/or a level of granularity. For example, the NLP service 205 can process the input 213 via a local topic modeler to predict an association of the input 213 with one of a plurality of contexts 214. In another example, the NLP service 205 can process the input 213 via a random forest classification model to generate a prediction for the most likely intent 215 with which the input 213 may be associated. In yet another example, the NLP service 205 can process the input 213 through the LLM service 208 to generate the response 216.

The NLP service 205 can process a first conversational input via a natural language processing (NLP) algorithm to determine a context 214 based on the first conversational input and a channel 218 and/or container 219 associated with receipt of the first conversational input. The channel 218 can include, for example, a particular URL address. The container 219 can include, for example, a The NLP service 205 can further process the first conversational input via the NLP algorithm (e.g., or other NLP algorithm(s)) to determine a first intent based on the first conversational input and the context. The NLP service 205 can process a second conversational input via the NLP algorithm to determine an updated intent based on the first conversational input, the second conversational input, the first intent, the context, and/or the URL address.

The NLP service 205 can identify a contextual change between two or more conversational inputs. A contextual change can include a change from a first context to a second context (e.g., or any number of other contexts). A contextual change can include the inclusion of a second context in addition to the first context. The NLP service 205 can process a plurality of conversational inputs to determine if a context change occurs between a first subset of the conversational inputs and a second subset of the conversational inputs. The NLP service 205 can determine additional changes in context, as can be appreciated.

In an example scenario described in the following paragraph, the NLP service 205 determines a first context based on at least one of a plurality of first conversational inputs. The NLP service 205 and/or response service 207 iteratively processes the plurality of first conversational inputs, based on the first context, to generate a plurality of first responses individually corresponding to a respective one of the plurality of first conversational inputs. The NLP service 205 processes the plurality of first conversational inputs via one or more NLP algorithms and/or subservices and identifies a contextual change in a subset of the plurality of first conversational inputs. The NLP service 205 initiates a change from the first context to a second context based on the context change. The NLP service 205 and/or response service 207 iteratively processes a plurality of second conversational inputs, based on the second context, to generate a plurality of second responses individually corresponding to a respective one of the plurality of second conversational inputs.

In various embodiments, the NLP service 205 includes one or more subservices for analyzing conversational inputs. The NLP service 205 can include, but is not limited to, one or more sentence decomposers 251, one or more phrase analyzers 253, one or more resolvers 255, and one or more LLM training engines 257.

The sentence decomposer 251 can process natural language of an input 213 via one or more decomposition algorithms, techniques, or models. The sentence decomposer 251 can decompose a sentence, or sentence fragment, into constituent terms (e.g., words, punctuation, etc.). The sentence decomposer 251 can associate the constituent terms with one or more classes including, but not limited to, nouns, pronouns, verbs, adjectives, adverbs, prepositions, conjunctions, and interjections. The sentence decomposer 251 can associate the constituent terms with one or more subcategories including, but not limited to, common noun, proper noun, singular noun, plural noun, concrete noun, abstract noun, compound noun, collective noun, possessive noun, personal pronoun, reflexive pronoun, intensive pronoun, demonstrative pronoun, interrogative pronoun, indefinite pronoun, relative pronoun, action verb, linking verb, auxiliary verb, transitive verb, intransitive verb, coordinating conjunction, correlative conjunction, and subordinating conjunction. The sentence decomposer 251 can generate and tag the constituent terms with labels corresponding to the categories and subcategories. For example, an input 213 includes natural language “how many guests can I have in my suite?” The sentence decomposer 251 can decompose the input 213 into constituent terms “how,” “many,” “guests,” “can,” “I,” “have,” “in,” “my,” “suite,” and “?.” The sentence decomposer 251 can process each the constituent terms to associate the constituent term with one or more categories or subcategories. The sentence decomposer 251 can label “guests,” “I,” and “suite” as nouns, “can” and “have” as verbs, “in” as a preposition, “how many” as an adverb, “my” as an adjective, and “?” as an interrogation point or query.

The sentence decomposer 251 can employ one or more embedding models from the model 220 to generate embedded vectors based on the inputs 213. The sentence decomposer 251 can use, for example, the Word2Vec algorithm to generate embedded vectors for each individual word within the input 213. The sentence decomposer 251 can employ the embedding models to generate embedded vectors, for words, phrases, paragraphs, fragments, clauses, and/or any particular subset of the input 213. The sentence decomposer 251 can generate embedded vectors for the inputs 213 with an N number of dimensions (where N is an integer). The sentence decomposer 251 can store the embedded vectors into a vector database.

The phrase analyzer 253 can determine one or more of a context 214, intent 215, and a level of granularity of the input 213. The phrase analyzer 253 can process the input 213, and/or or the constituent terms and labels thereof, to associate the input 213 with one or more contexts 214, one or more intents 215, and/or a level of granularity. The phrase analyzer 253 can compare the input 213 to one or more knowledge bases 212. The phrase analyzer 253 can compare the input 213 to a plurality of knowledge bases 212 212, each knowledge base being associated with a different context 214. The phrase analyzer 253 can determine a match between the input 213 and an entry of the knowledge base 212. The phrase analyzer 253 can perform comparison and matching via any suitable similarity algorithm, technique, model, or combinations thereof. Non-limiting examples of similarity algorithms, techniques, and models include exact string matching, approximate string matching, fuzzy comparison, string-to-vector encoding and comparison, cluster comparison, mutual information classification, naïve string search, Naïve Bayes classification, support vector machines, neural networks (e.g., convolutional neural networks (CNN), recurrent neural networks (RNN), etc.), and keyword extractors (e.g., YAKE!, BERT, etc.).

For example, the phrase analyzer 253 can employ the embedded vectors and the vector database to compare a subset of words from the input 213 to determine one or more contexts 214, one or more intents 215, and/or the degree of granularity of the input 213. The phrase analyzer 253 can extract from the knowledge base 212 the vector database. The vector database can include all embedded vectors associated with the data stored in the data store 211. The vector database can include the embedded vector equivalent of the input 213 and can include the embedded vector equivalent of one or more corpuses. The phrase analyzer 253 can determine the context 214 of the input 213 by identifying similarities in the embedded vectors of the inputs with the embedded vectors of the corpuses. The phrase analyzer 253 can identify similar words between the input 213 and the corpuses by identifying embedded vectors that are nearest in the Multi-dimensional space. The phrase analyzer 253 can reject contexts 214 that have embedded vectors that are furthest from the input 213 in the Multi-dimensional space.

The phrase analyzer 253 can employ count vectors, TermFrequency-Inverse Document Frequency (TF-IDF), sentence embedding algorithms, and/or any particular natural language processing system to determine the intent 215 of the input 213. For example, the phrase analyzer 253 can employ the TF-IDF to identify the most commonly used word in the input 213 to identify the intent 215 of the input 213. In another example, the phrase analyzer 253 can employ sentence embedding algorithms to generate embedded vectors for phrases and/or sentences. The phrase analyzer 253 can compare the embedded vectors associated with the phrases and/or sentences of the input 213 to one or more vector databases that include embedded vectors for intents 215. The phrase analyzer 253 can choose the intent 215 that is most closely related to the embedded vectors of the phrases and/or sentences of the input 213. Though discussed in the context of the phrase analyzer 253, any particular component of the NLP service 205 can perform like functionalities.

The phrase analyzer 253 can perform intent class detection and entity class detection to process and tag natural language for purposes of associating the input 213 with context(s) 214, intent(s) 215, and/or a level of granularity. When referring to intent class detection and entity class detection, “intent” may refer to a desired action and “entity” may refer to a subject or object of the desired action. For example, an input 213 includes natural language of “how many guests can I have in my suite?” The phrase analyzer 253 can process the natural language and determine that phrases “how many” and “have in” are intents and terms “guest” and “suite” are entities.

The resolver 255 can associate the input 213 with context(s) 214, intent(s) 215, and/or a level of granularity based on outputs from the sentence decomposer 251 and phrase analyzer 253. The resolver 255 can compare the natural language of the input 213 (e.g., including any classifications, determinations, or tags applied to the natural language elements) to one or more knowledge base 212. The resolver 255 can identify a context 214 of the input 213 by determining a context 214 whose associated knowledge base(s) 212 demonstrate the greatest measure of similarity to the natural language of the input 213. The resolver 255 can identify an intent 215 of the input 213 by determining an intent 215 whose associated knowledge base(s) 212 demonstrate the greatest measure of similarity to the natural language of the input 213. The resolver 255 can apply one or more predetermined thresholds to positively associate an input 213 with a context 214 or intent 215. For example, the resolver 255 can associate an input 213 with a particular context 214 in response to determining that the input 213 matches a predetermined percentage of terms in a knowledge base 212 with which the particular context 214 is associated. The resolver 255 can apply heuristics or other rules for associating an input 213 with a context 214. For example, the resolver 255 can apply fuzzy matching rules such that potentially misspelled or incorrectly phrased natural language may still be associated with a proper context 214 and intent 215.

The NLP service 205 can perform context association in a rank-wise manner. For example, a plurality of knowledge bases 212 are each associated with a different context 214. The phrase analyzer 253 can generate or retrieve a first ranking of the multiple knowledge bases 212 (e.g., a default ranking or a ranking based on previous conversational inputs and a context 214 associated therewith). In the order of the ranking, the NLP service 205 can compare a first input 213 (e.g., or constituent terms and labels thereof) to each of the plurality of knowledge bases 212 (e.g., which may include comparing the first input 213 to a plurality of knowledge tiers of each of the plurality of knowledge bases 212). In response to determining a threshold-satisfying level of similarity to a particular knowledge base of the plurality of knowledge bases 212, the NLP service 205 may associate the first input 213 with the particular context 214 corresponding to the particular knowledge base 212 (e.g., and may suspend performing further comparisons to other knowledge bases 212 that are lower in the first ranking). In response to associating the first input 213 with the particular context 214, the NLP service 205 can generate a second ranking of the plurality of knowledge bases 212 in which the particular knowledge base 212 is a top-ranked entry. The NLP service 205 can compare a subsequent input 213 to the plurality of knowledge bases 212 by order of the second ranking. The NLP service 205 can match the subsequent input 213 to one of the plurality of knowledge bases 212 and an associated context 214 thereof. The NLP service 205 can generate a third ranking of the plurality of knowledge bases 212 based on the analysis of the subsequent input 213. Instead of or in addition to ranking knowledge bases, the NLP service 205 can generate and update a ranking of a plurality of contexts 214 (e.g., each of which may be associated with one or more knowledge bases 212).

The response service 207 can generate responses 216 for responding to inputs 213. The response service 207 can generate responses 216 based one or more factors including, but not limited to, natural language of the input 213, the context(s) 214 of the input 213, the intent(s) 215 of the input 213, a level of granularity of the input 213, metadata of the input 213, a computing device 203 associated with the input 213, a user profile 217 associated with the input 213, a channel 218 by which the input 213 was received, and historical data including, but not limited, to historical inputs 213 and data associated therewith (e.g., historical contexts, intents, granularity levels, etc.), historical responses 216, and user interactions. For example, the NLP service 205 can process an input 213 to associate the input 213 with a context 214 and an intent 215. The response service 207 can scan through a decision tree based on the associated context 214 and intent 215 to identify a response to the input 213.

The response service 207 can generate, train, and execute models 220 to identify or generate the response 216. For example, the response service 207 can train a random forest classification model to process an input 213, a context 214, and an intent 215, and generate a plurality of votes toward potential responses 216 for responding to the input 213. The response service 207 can train the random forest classification model to output a ranking of the potential responses 216 based on the votes. The response service 207 can determine a top-ranked entry of the ranking as the most suitable response 216 for responding to the input 213. In another example, the response service 207 can train a model 220 to determine a matching metric between an input 213 and each of a plurality of potential responses 216. Each of the plurality of potential responses 216 may be associated with one or more contexts 214, intents 215, and levels of granularity. The matching metric can represent a comparison between the context(s) 214, intent(s) 215, and level of granularity of the input 213 and those of each potential response 216. The response service 207 can train the model 220 to identify a response 216 based on determining that a top-ranked potential response 216 satisfies a predetermined matching metric threshold.

The response service 207 can inject dynamic content variables into a response 216 or modify one or more dynamic content variables of a response 216. The response service 207 can populate a dynamic content variable based on various factors and objects including, but not limited to, previous responses 216, previous inputs 213, user profiles 217, properties of a computing device 203 from which an input 213 was received (e.g., location, device type, etc.), user interaction data, and data from external services 226. User interaction data can include, but is not limited to, click rate, dwell time, referring domain, impressions, user ratings, and user feedback.

The response service 207 can analyze historical responses 216 and historical inputs 213 to generate various insights, such as, for example, popular inputs 213, common inputs 213 answered with a default response (e.g., a non-specific response from a base response track), and unique user encounters. The response service 207 can support trend identification by identify commonly requested goods and services. The response service 207 can identify health, safety, or security threats, for example, by determining that a plurality of historical inputs 213 are associated with a similar concern.

For example, an input 213 includes “how much is a beer at the ballpark?” The response service 207 can generate a response 216 that includes a dynamic content variable for the price of a beer at a particular venue (e.g., the ballpark). The response service 207 can retrieve, from the data store 211, a current price of a beer at the particular venue. Alternatively, the response service 207 can request and receive the current price of the beer from an external service 226, such as an inventory management system of the particular venue. The response service 207 can update the dynamic content variable to include the current price. In another example, the response service 207 generates a response 216 that includes a dynamic content variable for a user's name. To populate the dynamic content variable, the response service 207 can retrieve and process a user profile 217 to obtain the user's name and populate the dynamic content variable based thereon.

The response service 207 can analyze historical responses 216 and historical inputs 213 to identify a need to call the LLM service 208. To reduce the number of calls made to the LLM service 208, the response service 207 can determine if the input 213 is similar to one or more historical inputs 213 sent in the past by one or more computing devices 203. The response service 207 can identify similar historical inputs 213 by comparing embedded vectors of the input 213 to the embedded vectors of the historical inputs 213. The response service 207 can employ any particular technique (e.g., any natural language algorithm) for identifying similarities between the input 213 and the historical inputs 213. On identifying a particular historical input 213 that is substantially similar to the input 213, the response service 207 can send the corresponding historical response 216 to the computing device 203. The response service 207 can proceed to employing the NLP service 205 and/or the LLM service 208 to generate the response 216 when the response service 207 does not identify a particular historical input 213 similar to the input 213.

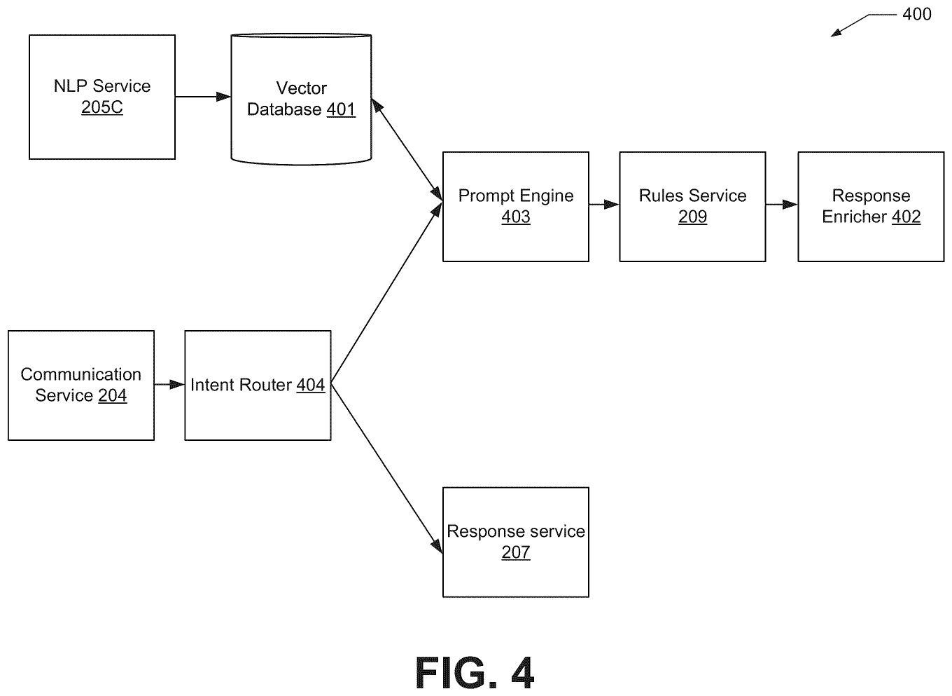

The rules service 209 can include a moderation service for moderating responses 216 generated by the NLP service 205 and/or the LLM service 208. The LLM service 208 can potentially generate incorrect, fictional, and/or offensive responses 216. To mitigate these issues, the rule service 209 can employ the moderation service to remove responses that fall below a quality threshold. The moderation service of the rules service 209 can identify offensive language, audio, imagery, or a combination thereof. The rules service 209 can remove the particular response 216 that include offensive content. The rules service 209 may store in a quarantined dataset of the data store 211 the knowledge bases 212, the contexts 214, the intents 215, and/or any other data that led to the generation of the offensive content by the LLM service 208 and/or the NLP service 205. By storing the knowledge bases 212, the contexts 214, the intents 215, and/or any other data that led to the generation of the offensive content in the quarantined dataset of the data store 211, the data can be further analyzed and audited for quality purposes. In another example, the rules service 209 can include a subset of the vector database that stores offensive language and other negatively impacting words or phrases. Continuing this example, the rules service 209 can generate embedded vectors for the response 216 and compare the embedded vectors with the embedded vectors of the subset of the database storing the offensive language and other negatively impacting words or phrases. The rule service 209 can generate a quality score based on the similarities identified between the embedded vectors of the offensive content and the embedded vectors of the response 216. The rule service 209 can reject any response 216 where the quality score fall below the quality threshold. The rule service 209 can send the rejected response 216 to a response enricher 402 (see FIG. 4) to re-process the response 216 to correct any particular deficiencies.

The rule service 209 can employ the moderation service to identify responses 216 that exhibit hallucinations, inaccuracies, false information, and/or any other information that is deemed as falling below the quality threshold. Hallucinations can be defined as responses 216 generated by the LLM service 208 and/or any particular Large Language Model that exhibits information that is not based on any knowledge base 212. Said differently, hallucinations are fictitious responses 216 that are generated by the LLM service 208 when not having the adequate information to generate an accurate and/or useful response 216. The rule service 209 can compare the knowledge base 212 using any particular technique (e.g., LLM service 208, natural language processing algorithms, embedded vectors) to identify inaccuracies, fictitious responses 216, and/or any particular error in the response 216. The rule service 209 can generate the quality score to include measurements that score the response 216 on its accuracy, correctness, and usefulness. The rule service 209 can reject the response 216 if the quality score falls below the quality threshold. The rule service 209 can send the rejected response 216 to the response enricher 402 to re-process the response 216 to correct any particular deficiencies.

The rule service 209 can determine the best response 216 from a plurality of responses 216. For example, the rule service 209 can determine the best response 216 based on the main response track, the fallback response track, and the base response track. In another example, the rules service 209 can determine the best response 216 from a second plurality of responses 216, where the second plurality of responses 216 are generated using various different techniques. The second plurality of responses 216 can be generated using various types of LLMs through the LLM service 208, the NLP service 205, and/or any particular natural language processing technique.

The rule service 209 can determine the best response 216 between the main response track, the fallback response track, and the base response track. The rule service 209 can select the best response 206 according to various criteria. For example, the various criteria can include but are not limited to, response length, context 214, intent 215, knowledge bases 212, and/or any other criteria for selecting between particular responses 216. For example, the rule service 209 can mandate minimum length of 15 words in the response 216. Continuing this example, the rule service 209 can reject responses 216 that do not include the 15 word minimum. In another example, the rule service 209 can employ the vector database and the embedded vectors to compare the similarities in the response 216 to the identified context 214, the identified intent 215, and the associated knowledge base 212. The rule service 209 can select the response 216 with the highest similarity (e.g., closest in the multi-dimensional space) to the identified context 214, the identified intent 215, and the associated knowledge base 212. The rule service 209 can select the response based on historical inputs 213. For example, the NLP service 205 can receive a first input 213, where the NLP service 205 generates the main response track to respond to the first input 213. Continuing this example, the NLP service 205 can identify from a second input 213 that the first response track was inadequate. Further continuing this example, the rule service 209 can select the fallback response track to respond to the second input 213. The contextual response system 201 can continue to iterate through the steps of providing alternative responses 216 in response to the input 213 rejecting the previous response (e.g., through text such as “I am not satisfied with this result”, a request to speak with a live agent, sending a consecutive input 213 substantially similar to a previous input 213).

The rule service 209 can select one response 216 from the plurality of responses 216 to send to the computing device 203. The NLP service 205 and/or the LLM service 208 can generate more than one response 216 to the particular input 213. For example, the NLP service 205 can generate a first response 216 to a particular input 213 using various maps and selectable widget for interacting with the map. Continuing this example, the LLM service 208 can generate a second response 216 to the particular input 213 that includes a text description for directing the user of the computing device 203 to a bathroom. Further continuing this example, the LLM service 208 can generate a third response 216 to the particular input 213 that send an excerpt of the map found on the official website of the entity describing the location of all bathroom locations. The rule service 209 can identify the best response 216 from the plurality of responses 216 by identifying the response 216 that is most pertinent to the input 213. For example, the rule service 209 can identify the response that most closely aligns with the context 214 and/or the intent 215 of the input 213.

The rules service 209 can apply one or more rules to format a response 216 for transmission to a computing device 203 or presentation to a user thereof. The rules may include various factors, such as, for example, type of computing device 203 (e.g., tablet, smartphone, kiosk, etc.), channel 218, container 219, and properties of a user profile 217 (e.g., language, age, location, etc.). The rules service 209 can structure the response 216 into a particular communication format that may be based on the channel 218 by which the response will be transmitted and/or the computing device 203 intended to receive the response 216. Non-limiting examples of communication formats include text messages, instant messages (e.g., on any digital platform or service, such as a social media platform or business messaging service), push notifications, computer voice, and e-mail. The rules service 209 can modify a response 216 based on regulations or restrictions. For example, the rules service 209 can modify response 216 based on age-based restrictions, location-based restrictions, or time-based restrictions.

For example, a venue may suspend beverage services at a particular time. If the response service 207 generates a response 216 for providing information on accessing beverage services, the rules service 209 may process the response 216 and determine that the request for beverage services is beyond the particular time. In response to the determination, the rules service 209 may modify the response 216 (e.g., including retrieving a replacement response 216 from a fallback or base response track) to indicate that beverage services are not accessible at this time. In another example, a venue may restrict ticket sales to peoples 21 years of age and over. The response service 207 may generate a response 216 for facilitating purchase of tickets at the particular venue. The rules service 209 may process the response 216 and a user account 217 associated with an input 213 for which the response 216 was generated. The rules service 209 may determine that the user account 217 is associated with an individual under 21 years of age. The user account 217 may include one or more user profiles. In response to the determination, the rules service 209 may modify the response to indicate that the requested tickets are only purchasable to peoples 21 years of age and over.

The rules service 209 can apply one or more language-based policies to translate a response 216 from a first language to a second language. The rules service 209 can apply one or more content-based policies to censor or omit content containing restricted language (e.g., curse words, potentially offensive imagery, etc.). The rules service 209 can apply gender or sex-based rules to modify pronouns or other response language so as to conform to an intended recipient of the response 216. The rules service 209 can apply accessibility- or disability-based rules to format a response 216 for presentation to differently abled persons. For example, the rules service 209 can generate text descriptions of visual elements, thereby allowing communication of the visual elements to a visually impaired reader. As another example, where a response 216 includes multimedia or audio content, the rules service 209 can modify the response 216 to include a transcription of the content, thereby allowing communication of the content to an audio-impaired reader. As another example, an input 213 includes natural language requesting directions to a location. The rules service 209 can determine that the input 213 is associated with a person having mobility needs (e.g., based on one or more of a user profile 217, context 214, or intent 215). In response to the determination, the rules service 209 can instruct the response service 207 to identify or generate a response 216 that accommodates users with mobility impairments (e.g., utilizing disability-accessible routes to the location, connecting a user to an employee at the location, etc.).

The contextual response system 201 can aggregate all inputs 213, contexts 214, intents 215, and responses 216 for further processing. The contextual response system 201, for example, can generate one or more reports that analyze various aspects of the data gathered by the contextual response system 201. For example, the contextual response system 201 can generate a pie chart that show a breakdown of the most common intents 215 and/or contexts 214 used in the last 30 days. In another example, the contextual response system 201 can flag the contexts 214 and intents 215 that lead to the most users requesting to interact with a particular live agent. The contextual response system 201 can augment the response 216 with a survey to gather information from the user. The contextual response system 201 can generate a report that ranks the top most used containers 219, the top most used channels 218, and the top most used intents 215 and contexts 214, and/or any other information gathered by the contextual response system 201. The contextual response system 201 can generate a particular report that pinpoints on a map the regions that interact with the contextual response system 201 the most. The contextual response system 201 can gather any particular information and/or data from the computing device 203 for further processing and analyses.

The computing device 203 can include any network-capable electronic device, such as, for example, personal computers, smartphones, and tablets. The computing device 203 can transmit inputs 213 to the communication service 204 (e.g., via one or more channels 218), such as a requests or conversational inputs. The computing device 203 can include, but is not limited to, one or more inputs devices 221, one or more displays 223, and an application 225. The input device 221 can include one or more buttons, touch screens including three-dimensional or pressure-based touch screens, camera, finger print scanners, accelerometer, retinal scanner, gyroscope, magnetometer, or other input devices. The display 223 can include, for example, one or more devices such as liquid crystal display (LCD) displays, gas plasma-based flat panel displays, organic light-emitting diode (OLED) displays, electrophoretic ink (E ink) displays, LCD projectors, or other types of display devices, etc.

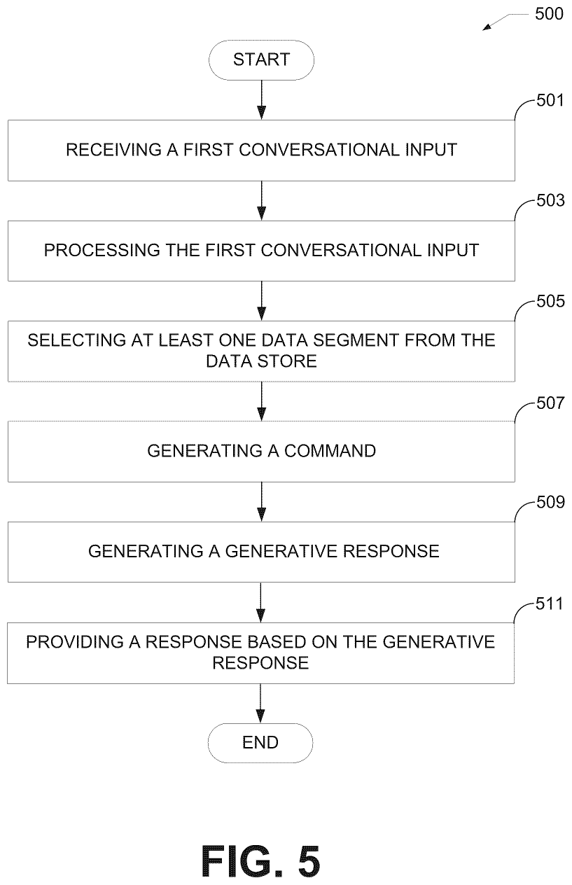

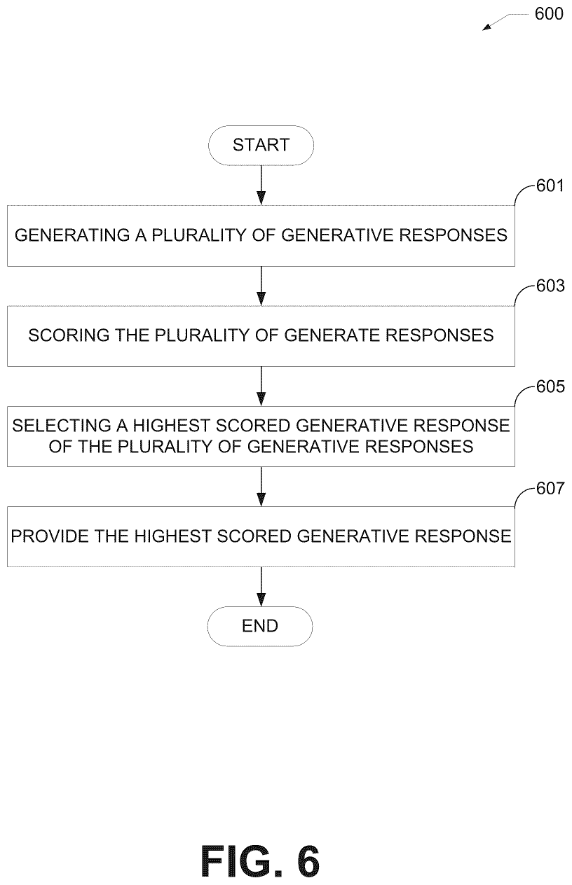

The application 225 can support and/or execute processes described herein, such as, for example, the response generation process 500 and 600 shown in FIGS. 5 and 6, respectively, and described herein. The application 225 can correspond to a web browser and/or a web page, a mobile app, a native application, a service, or other software that can be executed on the computing device 203. Where functions and actions of the computing device 203 are described herein, any of the functions and actions may be performed by the application 225. In some embodiments, the application 225 may be a standalone deployment of the contextual response system 201. The application 225 can generate user interfaces and cause the computing device 203 to render user interfaces on the display 223. For example, the application 225 generates a user interface including a user session comprising conversational inputs and responses to the conversational inputs.

The application 225 can generate inputs 213 and transmit the inputs 213 to the contextual response system 201. The application 225 can transmit additional factors including, but not limited to, device data, user profile data, and metadata. The application 225 can receive, from the contextual response system 201, responses 216. The application 225 can store inputs 213 and responses 216 in memory of the computing device 203 and/or at a remote computing environment configured to communicate with the computing device 203.

The external service 226 can include any public or private, network-capable computing environment (e.g., including virtual, cloud-based systems and physical computing systems). Non-limiting examples of the external service 226 include a language translation service, a location, mapping, and/or navigation service, a reservation management service, a point of sale service or other pricing service (e.g., such as a website or database of a food vendor or merchandise vendor), an inventory management service, a social media platform, a media platform (e.g., news outlet, news website, etc.), a multimedia platform (e.g., a streaming service, video on demand service, radio broadcast service, etc.), a health information service, a website of the entity employing the contextual response system 201, or a public or private service associated with accessing event information (e.g., ticket prices, ticket availabilities, reservation confirmations, scheduling information, etc.). The external service 226 can transmit various information to the contextual response system 201, including, for example, translations of conversational inputs, values of dynamic content variables (e.g., or information by which the same may be determined), and variables for generating a response 216 (e.g., such as a location of a computing device 203, weather condition, product availability, etc.). The contextual response system 201 can transmit requests to the external service 226 and receive responses therefrom. For example, the NLP service 205 can transmit an input 213 of a first language to a translation service. The NLP service can receive, from the translation service, a translation of the input 213 in a second language (e.g., and the response service 207 may perform similar processes for a response 216). As another example, the response service 207 can request a location of the computing device 203 from a location service. The response service 207 can receive, from the location service, a current location of the computing device 203. As another example, the response service 207 can request a current price of a particular beer from a point of sale system. The response service 207 can receive, from the external service 226, the current price of the particular beers. As another example, the response service 207 transmits transaction data to a transaction processing service. The transaction processing service can authenticate the transaction data to process a corresponding transaction. The response service 207 can receive, from the transaction service, a confirmation that the transaction was successfully processed. The contextual response system 201 can communicate via any suitable network mechanism, such as an application programming interface (API).

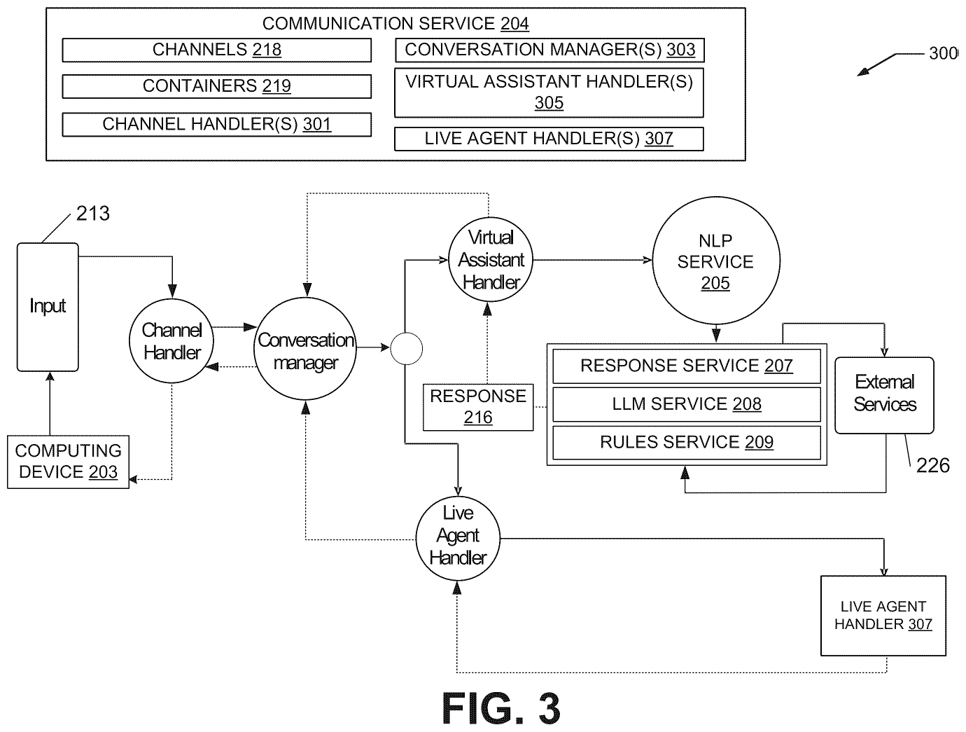

Referring now to FIG. 3, illustrates is an example communication service 204 and communication workflow 300. The communication service 204 can include, but is not limited to, containers 219, one or more channel handlers 301, one or more conversation managers 303, one or more virtual assistant handlers 305, and one or more agent handlers 307.

While not shown in FIG. 3, the channel handler 301 can include, but is not limited to, a channel input manager, a conductor, a data collector, and a channel output manger. In some embodiments, the conversion manager 303 is an element or subservice of the channel handler 301. The channel input manager can associate the input 213 with a channel 218. The channel input manger can receive a request that includes the input 213. The channel input manager can process the request to extract the input 213 and/or generate additional metadata (e.g., timestamp, user identifier, device identifier, location, associations with previous inputs 213, contexts 214, intents 215, or responses 216, etc.). The conductor can relay the input 213 to the conversation manager 303. The data collector can generate metadata associated with user sessions (e.g., also referred to herein as conversations). Non-limiting examples of the metadata include time stamps, user session identifiers, input identifiers, response identifiers, computing device identifiers, user account identifiers, and a time series record of a user session. The channel output manager can transmit responses 216 to computing devices 203 (e.g., via the same or a different channel 218 by which a corresponding input 213 was received).

The conversation manager 303 can associate a user session with a container 219 and can retrieve and deploy instances of the contextual response system 201 (e.g., or one or more elements thereof) based on the container 219. The conversation manager 303 can associate a user session with a container 219 by processing the input 213 and a channel 218 by which the input 213 was received (e.g., such as a particular URL address). The conversation manager 303 can retrieve or call instances of the NLP service 205, response service 207, the LLM service 208, and/or rules service 209 that are associated with the container 219. The conversation manager 303 can provide the input 213 to the one or more initiated services for processing. The conversation manager 303 may also provide additional data for processing, such as metadata or previous inputs 213, contexts 214, intents 215, or responses 216.

The conversation manager 303 can configure one or more settings of the NLP service 205, response service 207, and/or rule service 209 based on the container 219. Non-limiting examples of settings include input and output language, input and output vernacular, time zone, output character limits, and censorship of personal identifiable information or other protected data. The conversation manager 303 can retrieve one or more knowledge bases 212 associated with the container 219 and/or a context 214 with which the input 213 is determined to be associated. The conversation manager 303 can provide the one or more knowledge bases 212 to the NLP service 205 for processing. The conversation manager 303 can manage a time-series sequence of conversational inputs and outputs, including determining whether a virtual assistant handler 305 or a live agent handler 307 may respond to an input 213. In one example, the input 213 includes a request to speak to a live agent, human, or non-bot. Based on the input 213, the conversation manager 303 can relay the user session and the input 213 to a live agent handler 307. In some embodiments, the response service 207 performs the action(s) of determining whether a live or virtual agent may respond to an input 213. The conversation manager 303 may initially relay the input 213 to a virtual assistant handler 305. The conversation manager 303 may redirect the input 213 to a live agent handler 307 in response to receiving an indication from the virtual assistant handler 305 of a failure to respond to the input 213.

In the communication workflow 300, the solid line may indicate a pathway of an input 213 as received from the computing device 203 at the communication service 204 and processed via the NLP service 205 or a live agent handler 307. The dashed line may indicate a pathway of a response 216 as generated by the response service 207 or LLM service 208, formatted by the rules service 209, and transmitted to the computing device 203.

The computing device 203 can transmit the input 213 to the communication service 204 via a channel (not shown). The channel handler 301 can receive the input 213 and determine the channel by which the input 213 was received. The channel handler 301 can relay the input 213 and an indication of the channel to the conversation manager 303. The conversation manager 303 can process the input 213 and the indication of the channel and, based thereon, associate the input 213 with a container 219. The conversation manager 303 can determine whether the input 213 may be responded to via a virtual agent (e.g., the NLP service 205 and response service 207) or a live agent. The conversation manager 303 can relay the input 213 to either of the virtual assistant handler 305 or the live agent handler 307 based on the determination. The virtual assistant handler 305 and the live agent handler 307 may be instances of said elements associated with the container 219. The conversation manager 303 can determine if the input 213 is associated with historical inputs 213, a previous channel, a previous container 219, a past conversation conducted by the user account 217, and/or any other identified that indicated the input 213 is associated with previously gathered data. In the case that the conversation manager 303 identifies that the input 213 is associated with a previously held communication with the contextual response system 201 and/or a live agent, the conversation manager 303 can aggregate each previously associated data (e.g., historical inputs 213, historical outputs/responses 216, historical contexts 214, historical intents 215, historical knowledge bases 212, previous containers 219, previous channels 218) and use the previously associated data to process the input 213 accordingly. For example, if the input 213 is a follow up question based on a previous communication held with the contextual response system 201, the conversation manager 303 can send the computing device 203 the previous conversation for rendering above the input 213 in the container 219. In another example, in the case that the input 213 is a similar communication as one held in the past, the conversation manger 303 can load the previous responses 216 to reduce the number of calls made to the NLP service 205 and/or the LLM service 208.

The virtual assistant handler 305 can receive the input 213 from the conversation manager 303. The NLP service 205 can process the input 213 and one or more knowledge bases 212 of the container 219 to determine a context 214 of the input 213 and an intent 215 of the input 213. The NLP service 205 can process the input 213 and one or more knowledge bases 212 using the LLM service 208. The NLP service 205 may determine the context 214 based at least in part on the input 213 and the container 219 (e.g., or the channel 218 with which the container is associated). The NLP service 205 may determine the intent 215 based at least in part on the input 213 and the context 214.

The response service 207 can receive the input 213, context(s), and intent(s) from the NLP service 205. The response service 207 can generate a response 216 based on the input 213, the context(s), and the intent(s). Based on the complexity of the context 214 and/or the intent 215, the response service 207 can direct the input to the live agent and/or the LLM service 208 or generate the response 216. For example, the response service 207 can identify historical data associated with the input 213 (e.g., historical inputs 213, historical responses 216, historical knowledge bases 212) and generate the response 216 using the historical data. In another example, the response service 207 can identify that the input 213 has a low level of complexity and complete the response 216 without high volumes of data and/or without using the LLM service 208. Other instances that identify the input 213 having a low level of complexity can include when the response 216 falls below a response word threshold, the input 213 falls below an input word threshold, the response service 207 can send a pre-written response (e.g., pre-written responses, excerpts from one or more knowledge bases 212), and/or the response service can generate the response 216 without using the LLM service 208. For example, the response service 207 can generate responses 216 to the inputs 213 such as, “where is the bathroom” or “how much are hotdogs” without employing the LLM service 208. Continuing this example, the response service 207 can generate responses 216 to the inputs 213 using pre-written responses and/or excerpts from one or more knowledge bases 212. By determining whether the response service 207 or the live agent handles the response 216 to the input 213, the contextual response system 201 can reduce the number of calls made to the LLM service 208 (e.g., ChatGPT, Bard).

On determining that the LLM service 208 is best suited for responding to the input 213, the response service 207 can send the LLM service 208 all pertinent information (e.g., the input 213, the context(s) 214, and the intent(s) 215, the knowledge bases 212). The LLM service 208 can generate the response 216 to the input 213 by employing one or more Large Language Models (e.g., generative artificial intelligence (AI) algorithms. The LLM service 208 can analyze one or more documents provided by the entity to extract the response 216 directly form the document.

The response 216 can include a dynamic content variable. The response service 207 can request and receive a value of the dynamic content variable from an external service 226. The response service 207 can update the dynamic content variable based on the value. The rules service 209 can receive the response 216 from the response service 207. The rules service 209 can format the response 216 for various purposes including, but not limited to, suitability for transmission via the channel by which the input 213 was received and personalization. The rules service 209 can analyze the response 216 to determine if the response 216 is adequate for transmission to the computing device 203 or if the response should be reevaluated. The virtual assistant handler 305 can relay the formatted response 216 from the rules service 209 to the conversation manager 303. Alternatively, the assistant handler 305 receives a response from the live agent handler 307 and relays the live agent response to the conversation manager 303. The conversation manager 303 can relay the formatted response 216, or live agent response, to the channel handler 301. The channel handler 301 can transmit the formatted response to the computing device 203 via the same or a different channel by which the input 213 was received.

Referring now to FIG. 4, illustrated is a generative response workflow 400, according to one embodiment of the present disclosure. The generative response workflow 400 can demonstrate the various interactions performed by the contextual response system 201 for generating the response 216. The generative response workflow 400 can be performed through the contextual response system 201 and/or any system distributed across the networked environment 200.

The NLP service 205 can process data stored in the data store 211 to create the vector database 401. The NLP service 205 can receive data from the external services 226, historical data stored in the data store 211, and/or any particular data gathered by the contextual response system 201. The NLP service 205 can, for example, receive knowledge bases 212 from the communication service 204. The knowledge bases 212 can include information received from the external services 226 and/or historical data gathered, generated, and processed by the contextual response system 201 (e.g., past inputs 213, past responses 216, past intents 215, past contexts 214). The external services 226 can include any publicly or privately available resource of the particular entity employing the contextual response system 201 (e.g., company, event operator, etc.). The communication service 204 can receive knowledge bases 212 that include all user manuals, policies, textual documents, contracts, user agreements, pre-written responses, hybrid responses, and/or any pertinent textual documents associated with the entity employing the contextual response system 201. The communication service 204 can send the knowledge bases 212 to the NLP service 205 for further processing.

The NLP service 205 can process the knowledge bases 212 by generating one or more embedded vectors. By embedding vectors into certain components of a particular document provided by the entity, the historical communications conducted by the contextual response system 201, and/or any other data stored in the data store 211, the contextual response system 201 can include numerical equivalents to the data stored in the data store 211. For example, the NLP service 205 can generate one or more embedded vectors for a safety and wellness policy for attendees at Truist Park. The NLP service 205 can generate one or more contexts 214 and intents 215 for the safety and wellness policy for attendees at Truist Park based on the associated embedded vectors. The NLP service 205 can generate the embedded vectors for the particular documents received from the external services 226 such that the contexts 214 and the intents 215 of the particular documents are comparable to inputs 213. The NLP service 205 can employ any particular technique discussed herein to generate embedded vectors for the particular documents received from the external services 226. For example, the NLP service 205 can generate embedded vectors using Word2Vec algorithm for each word present in the safety and wellness policy document for attendees at Truist Park. The NLP service 205 can perform analyses to identify various contexts 214 and intents 215 in the particular document. For example, the NLP service 205 can assign the safety and wellness policy document various contexts 214 and intents 215 that are most prevalent within the document based on identifying clusters of terms in the multi-dimensional space. On generating the embedded vectors, the NLP service 205 can store the embedded vectors in the vector database 401.

The communication service 204 can receive one or more inputs 213 from the computing device 203. The communication service 204 can determine if the input 213 is associated with historical inputs 213, historical containers 219, and/or any communication previously conducted between the computing device 203 and the contextual response system 201. On identifying that the input 213 is associated with a historical communication, the communication service 204 can reestablish the communication previously conducted between the computing device 203 and the contextual response system 201. The communication service 204 can send the input 213 to the intent router 404.

The intent router 404 can function as a combination of the NLP service 205 and the communication service 204. For example, the intent router 404 can include both the NLP service 205 and the communication service 204 and can be a component of the contextual response system 201. The intent router 404 can be a term used to refer to both the NLP service 205 and the communication service 204. The intent router 404 can extract the contexts 214 and the intents 215 from the input 213. The intent router 404 can extract the contexts 214 and the intents 215 using the NLP service 205 and/or the LLM service 208. For example, the NLP service 205 can extract the intent 215 using a Bidirectional Encoder Representations from Transformer (BERT) model. Continuing this example, the BERT model can generate one or more embedded vectors for the input 213. Based on the embedded vectors, the NLP service 205 can determine the intent 215 of the input. Based on the intent 215, the communication service 204 can direct the input 213 to various different locations for processing. For example, if the intent 215 is associated with speaking with the live agent, the communication service 204 can direct the input 213 and the channel 218 to connect with the live agent. In another example, if the intent 215 is associated with the input 213 that has low complexity, the communication service 204 can send the input to the response service 207 for generating the response 216. In another example, if the intent 215 is associated with a response that has higher complexity (e.g., requires exploring multiple documents, requires analyzing large dataset, requires a complex response that is not pre-written), the communication service 204 can send the input 213 to the LLM service 208 for generating the response 216.

The intent router 404 can direct the input 213 and all other associated data to the response service 207. The intent router 404 can direct the input 213 to the response service 207 on recognizing that the input 213 can be answered by the response service 207. By minimizing the calls to the LLM service 208 and/or the live agent, the contextual response system 201 can reduce the economic expenses associated with using the LLM service 208 and/or the live agent. The response service 207, as discussed herein, can generate the response 216 to the input 213. For example, the response service 207 can employ one or more pre-written responses for answering the input 213. The pre-written responses can include any response that includes pre-written text. In one example, the pre-written response can include a response that only includes text received from the external services 226. In another example, the pre-written response can include a hybrid response. The hybrid response can function as a subset of pre-written responses received from the external services 226 that include portions of pre-written text and one or more code snippets.

The intent router 404 can determine that the hybrid response is the most appropriate response to the input 213. For example, the hybrid responses can be stored in the vector database 401. Continuing this example, the intent router 404 can determine, by comparing the vectorized version of the input 213 to entries in the vector database 401, that the input 213 is most closely related to a particular hybrid response. On generating a response using a particular hybrid response, the response service can employ the code snippets imbedded into the hybrid response to call the LLM service 208. The LLM service 208 can generate the portion of the hybrid response to which the code snippet corresponds. Hybrid responses can further enhance efficiency by reducing the request size from the LLM service 208 and minimizing the overall use of the LLM service 208 and the associated economic costs.

Each code snippet can include specific information that defines the particular bounds for which the LLM service 208 should employ to generate its response. For example, the code snippet can include a subset of specific data and a specialized prompt (also referred to herein as a command). The subset of specific data can include various document types, contexts 214, and intents 215 that are required for use in generating the response for the code snippet. The response service 207 can aggregate the subset of specific data defined by the code snippet from the vector database 401 and/or the data store 211 to later input into the LLM service 208. Specialized prompt can include a prompt either received from the external services 226 or generated by the LLM service 208. The specialized prompts can define the specific request made to the LLM service 208 for generating a specific response. For example, the specialized prompt can include textual information defining the bounds of the request made to the LLM service 208 such that the LLM service 208 adequately generates the specific response.

The response service 207 can generate the specialized prompt by processing the input 213, the associated hybrid response, and the subset of specific data defined by the code snippet to create a textual input used to define a particular request from the LLM service 208. For example, the input 213 can include “What is the return policy for tickets on the day of the game?” Continuing this example, the intent router 404 can process the input 213 to determine that a particular hybrid response is best suited to respond to the input 213. The response service 207 can extract from the vector database 401 all pertinent data associated with return policies and/or the subset of specific data defined by the associated code snippet of the hybrid response. The response service 207 can generate through the LLM service 208 a specialized prompt based on the pertinent data associated with the return policies, the input 213, and/or the subset of specific data of the code snippet. The response service 207 can feed the specialized prompt and the subset of specific data into the LLM service 208 to generate a response that answers the question regarding same-day return policies. The response service 207 can store the specialized prompts in the knowledge base 212 and/or the vector database 401 for future retrieval and use.

By using specialized prompts, requests made to the LLM service 208 can be smaller in size and more focused to generate accurate results. Smaller prompt sizes used by the LLM service 208 can further lead to reduced latency and quicker response times. By creating a repository of specialized prompts in the knowledge base 212, the contextual response system 201 can reference specialized prompts for use in the LLM service 208.

Though discussed in the context of hybrid responses and the response system 207, the prompt engine 403 can generate specialized prompts for inputs 213 where the intent router 404 determines that a generated response is best suited. For example, any particular service of the contextual response system 201 can generate the specialized prompt for generating specific responses from the LLM service 208. This and other aspects of the specialized prompts, as related to the prompt engine 403 and the generated responses, may be found in further detail herein.

The intent router 404 can direct the input 213 to the prompt engine 403. The intent router 404 can direct the input 213 to the prompt engine 403 to have the LLM service 208 generate the response 216. The intent router 404 can determine that the LLM service 208 is best suited for responding to inputs 213 when a pre-written response is unavailable (e.g., a fully generated response). The prompt engine 403, on receiving the input 213 from the intent router 404, can compare the contexts 214 and intents 215 associated with the input 213 with the embedded vectors stored in the vector database 401. For example, the prompt engine 403 can use K-Nearest Neighbors Algorithm, Support Vector Machines, or K-dimensional trees to identify the data most pertinent to the input 213 by comparing the embedded vectors of the input 213, the context 214, and the intent 215 with the embedded vectors stored in the vector database 401. The prompt engine 403 can extract the data that corresponds with the input 213. For example, the input 213 can include “how much will my annual percentage rate (APR) change year to year for my credit card?” Taking the embedded vectors generated from the particular input 213 of the previous example, the prompt engine 403 can identify various documents (e.g., credit card terms and agreement form) stored in the knowledge data 212 that pertain to the APR of the particular credit card. The prompt engine 403 can generate a specific prompt by analyzing the various identified documents associated with APR of the particular credit card, the input 213, and/or any other associated information. Further continuing this example, the prompt engine 403 can send the input 213, the associated identified documents, and the specialized prompt to the LLM service 208 for the LLM service 208 to parse through the associated identified documents and generate a particular response 216 accordingly. By generating embedded vectors of all the data received by the contextual response system 201, inputs 213 can be compared to the data stored in the data store 211 to identify information that is pertinent to the input 213. On identifying all the information that is pertinent to the input 213, the information and the input 213 can be sent to the LLM service 208 to generate the response 216. By using information that is pertinent to the input 213 and generating a specific prompt that more closely defines the request made by the input 213, the LLM service 208 can more accurately generate the response 216 due to the refined subset of data used for the basis of generating the response 216.

On generating the response 216 using the LLM service 208, the prompt engine 403 can send the response 216 to the rule service 209. The rule service 209 can analyze the response 216 to ensure the response 216 meets various standards. The rule service 209 can correct or reject the response 216 if the response 216 includes offensive/inappropriate content and/or includes hallucinations. For example, the response 216 can compare each word of the response 216 to identify offensive language. On identifying an instance of offensive language, the rule service 209 can either remove the word entirely, reject the response 216, or replace the word with an alternative accepted term. The rule service 209 can reject the response 216 if the rule service 209 identifies an instance of hallucinations. The rule service 209 can compare the intent 215, the context 214, and the input 213 to the response 216 using embedded vectors. The rule service 209 can set a dissimilarity threshold such that if the response 216 surpasses the dissimilarity threshold based on the distances between the analyzed embedded vectors, the rule service 209 can reject or adjust the response 216. For example, the rule service 209 can reject the response 216 and send an alternative response 216 stating, “Sorry, I'm not sure if I can help with that. Please wait while I connect you with a live agent.”

The rule service 209 can send the response 216 to a response enricher 402. The response enricher 402 can change the response 216 if the rule service 209 identifies a deficiency in the response (e.g., hallucinations, offensive content, incorrect content). The response enricher 402 can further augment responses 216 that are approved by the rule service 209 (e.g., responses 216 that did not have identifiable issues). The response enricher 402 can append various enriched components to the response 216. For example, a particular input 213 can include, “What is the sizing measurements for an adult large jersey?” In response to the input 213, the LLM service 208 can generate a particular response 216 stating, “The adult large jersey has an X waist size, an X neck size, an X shoulder size, and an X length.” Continuing this example, the response enricher 402 can receive the particular response 216 and add a selectable URL address to the particular response 216. The selectable URL address can include a link to the online store where the user can purchase the particular adult large jersey. The response enricher 402 can augment the response 216 with any particular intractable component. For example, the response enricher 402 can add more than one selectable component to the response 216 such that the user can select from more than one course of action. The selectable components added to the response 216 by the response enricher 402 can include any particular course of action. For example, the selectable components can include a map, a website, a GPS location, and a video player. The response enricher 402 can add other forms of media to the response 216. For example, the response enricher 402 can add an image of a map to a particular response 216 describing the location of all bathrooms at a stadium.

The response enricher 402 can combine the response 216 generated by the LLM service 208 with one or more enriched components. For example, the enriched components can include but are not limited to buttons, selectable content, images, videos, quick replies, and dynamic feed content. The response enricher 402 can be a component of the NLP service 205 and can generate the various enriched components. The response enricher 402 can generate the enriched components based on the contexts 214 and the intents 215 of the associated input 213.

The response enricher 402 can determine the need for enriching responses 216 with the enriched components. As one example, the response enricher 402 can evaluate the context and/or intent to determine whether the system is configured to provide multiple types of features in the response. For example, the response enricher 402 can replace the response 216 generated by the LLM service 208 with one or more pre-written or generated responses. The response enricher 402 can replace the response 216 on determining that the response 216 does not require a particular response 216 from the LLM service 208 (e.g., when a user is asking for the price of a ticket) or fits a particular criteria. In another example, the response enricher 402 can augment the response 216 generated by the LLM service 208 with one or more pre-written or generated responses on determining that the response 216 lacks information present in the pre-written responses. The response enricher 402 can enrich the response 216 using the enriched components. The response enricher 402 can determine whether or not to enrich the response 216 based on the context 214 and the intent 215 of the input 213. For example, the input 213 can include, “When is X player's bobble head night?” and the NLP service 205 can determine the intent 215 as requesting promotional information on bobble heads. The LLM service 208 can generate the response 216 with natural language stating the date of the bobble head night for the particular player. The response enricher 402 can identify the intent 215 and add to the response 216 a calendar illustrating all the bobble head nights for each of a plurality of players. The calendar can be generated by the response enricher 402 and/or any other service of the contextual response system 201. The response enricher 402 can add buttons to facilitate purchasing of goods, services, or tickets to an event. In some embodiments, the response enricher 402 can receive pre-written responses from an administrative user and save the responses 216 in the data store 211. The response enricher 402 can pull these pre-written responses when specific criterial are satisfied and replace or augment the response 216 with the pre-written and saved response 216.

The response enricher 402 can determine that the response 216 generated by the LLM service 208 is sufficient for responding to the input 213. For example, the response enricher 402 can determine if the intent 215 associated with the input 213 and the response 216 requires enrichment. On determining that the response 216 does not require enrichment, the response enricher 402 can send the response 216 generated by the LLM service 208 to the computing device 203. The response enricher 402 can receive inputs that are controllable by the entity employing the contextual response system 201 for determining the type of enrichment, the amount of enrichment, and/or any other aspect performed by the response enricher 402. For example, the entity can specify the number of times for the response enricher 402 to enrich the response 216, the types of enrichments performed by the response enricher 402, and/or any other aspect of the response enricher 402.

Referring now to FIG. 5, illustrated is a flowchart of a process 500, according to one embodiment of the present disclosure. The process 500 can demonstrate a technique for generating the response 216 for one or more inputs 213. The process 500 can be performed by the contextual response system 201, the computing device 203, or a combination thereof.

At box 501, the process 500 can include receiving a first conversational input (e.g., input 213) of a plurality of sequential conversational inputs via the computing device 203, wherein the first conversational input is associated with a particular uniform resource locator (URL) address. The contextual response system 201 can receive the first conversational input of the plurality of sequential conversational inputs via the computing device 203, wherein the first conversational input is associated with the particular URL address. The contextual response system 201 can establish a communication with the computing device 203 using the URL address. For example, the computing device 203 can access the URL address through a web browser application and the URL address can render a particular container 219. The container 219 can establish the communication between the computing device 203 and the contextual response system 201. The computing device 203 through the container 219 can send subsequent conversational inputs to the contextual response system 201.

At box 503, the process 500 can include processing the first conversational input via at least one natural language processing (NLP) algorithm to determine at least one intent based on the first conversational input. The contextual response system 201 can process the first conversational input via the at least one NLP algorithm to determine the at least one intent based on the first conversational input. The NLP service 205 can determine one or more intents 215 associated with the input 213 received form the computing device 203. The NLP service 205 can employ the LLM service 208 and/or any particular NLP algorithm to generate the intents 215 associated with the input 213. For example, the NLP service 205 can employ the Word2Vec algorithm to generate embedded vectors for the input 213. The NLP service 205 can determine the intents 215 associated with the input 213 based on the embedded vectors.

At box 505, the process 500 can include selecting at least one data segment from the data store 211 based on the at least one intent 215. The contextual response system 201 can select the at least one data segment from the data store 211 based on the at least one intent 215. The NLP service 205 and/or the communication service 204 can employ the vector database 401 from the data store 211 to identify and extract the data segment that closest relates to the intent 215 of the input 213. The NLP service 205 and/or the communication service 204 can, for example, employ the embedded vectors of the intent 215 and/or the input 213 to compare to the vector database 401. The vector database may include all text documents provided by the entity, positively received historical responses, and/or any other information received by the contextual response system 201. The NLP service 205 and/or the communication service 204 can determine the data segment that most closely relate to the intent 215 and/or the input 213 based on the embedded vectors.

At step 507, the process 500 can include generating a command comprising the at least one data segment. The NLP service 205 and/or the prompt engine 403 can generate the command comprising the at least one data segment. The command can include the data segment, the input 213, a request to respond to the input 213 according to the data segment, and/or any other information necessary for the LLM service 208 to generate a particular response 216 based on the input 213. The command can include the specialized prompt generated by the prompt engine 403 requesting a particular response from the LLM service 208. The command, for example, can include the data segment (e.g., all pertinent data extracted from the vector database 401 and associated with the input 213) concatenated with the input 213 and the request to respond to the input 213 based on the data segment (e.g., the specialized response). The NLP service 205 can send the command to the LLM service 208 for further processing.

At step 509, the process 500 can include generating a generative response by performing the command with a generative artificial intelligence (AI) algorithm. The contextual response system can generate the generative response by performing the command with the generative artificial intelligence (AI) algorithm (e.g., the LLM service 208). The NLP service 205 can send the command to the LLM service 208. The LLM service 208 can generate the generative response. The LLM service 208 can process the command using ChatGPT, Bard, and/or any Large Language Model and generate the generative response based on the command. In the case multiple generative AI algorithms are used to create more than one generative response, the NLP service 205 can score each generative response and select the best generative response. For example, the NLP service can evaluate the generative responses based on accuracy, correctness, conciseness, and/or any other particular metric.

At step 511, the process 500 can include providing a response to the first conversational input based on the generative response. The contextual response system 201 can provide the response 216 to the first conversational input based on the generative response. The rule service 209 and the response enricher 402 can process the generative response to formulate the response 216. The rule service 209 can review the generative response to ensure the generative response does not include offensive language, incorrect information, and/or exhibits hallucinations. For example, the rule service can score the generative response using any particular NLP algorithm. Continuing this example, based on the score, the rule service 209 and/or the response enricher 402 can modify the generative response to comply with at least one guideline (e.g., does not include offensive language, has similar intents 215 and/or contexts 214 as the input 213). Further continuing this example, the response enricher 402 can provide the modified generative response as the response 216 to the first conversational input 213. The response enricher 402 can augment the generative response with various selectable components.

Referring now to FIG. 6 illustrated is a flowchart of a process 600, according to one embodiment of the present disclosure. The process 600 can demonstrate a technique for generating various responses 216 using various large language models and selecting the best response 216 for the input 213.

At box 601, the process 600 can include generate a plurality of generative responses individually corresponding to a plurality of generative AI algorithms, wherein the plurality of generative responses comprise the generative response and the plurality of generative AI algorithms comprise the generative AI algorithm. The LLM service 208 can generate the plurality of generative responses individually corresponding to the plurality of generative AI algorithms, wherein the plurality of generative responses comprise the generative response and the plurality of generative AI algorithms comprise the generative AI algorithm. The LLM service 208 can use various generative AI algorithms to generate generative responses. For example, the LLM service 208 can employ a combination of ChatGPT (e.g., GPT-3, GPT-3.5, GPT-4), Bard, LaMDA, PaLM, and LLaMA to generate various generative responses. The LLM service 208 can aggregate the generative responses from each of the generative AI algorithm for further processing.

At box 603, the process 600 can include scoring each of the plurality of generative responses. The NLP service 205 can score each of the plurality of generative responses. The NLP service 205 can score the plurality of generative responses based on length, conciseness, accuracy, and/or any other particular metric. For example, the NLP service 205 can increase scores for generative responses that have a short length but strongly correlate with the intent 215 of the input 213 (e.g., based on the correlation of embedded vectors of the generative response and the intent 215). In another example, the NLP service can increase scores for generative responses that are substantially similar to the knowledge base 212. In yet another example, the NLP service can increase scores for generative responses if the generative response shares many similarities to historical responses 216 that have been deemed successful.

At box 605, the process 600 can include selecting a highest scored generative response of the plurality of generative responses. The NLP service 205 can select the highest scored generative response of the plurality of generative responses. The NLP service 205 can rank the generative responses based on the scores.

At box 607, the process 600 can include providing the highest scored generative response as the response to the first conversational input based on the score. The contextual response system 201 can provide the highest scored generative response as the response 216 to the first conversational input based on the score. The contextual response system 201 can send the response 216 to the computing device 203 for rending through the container 219.

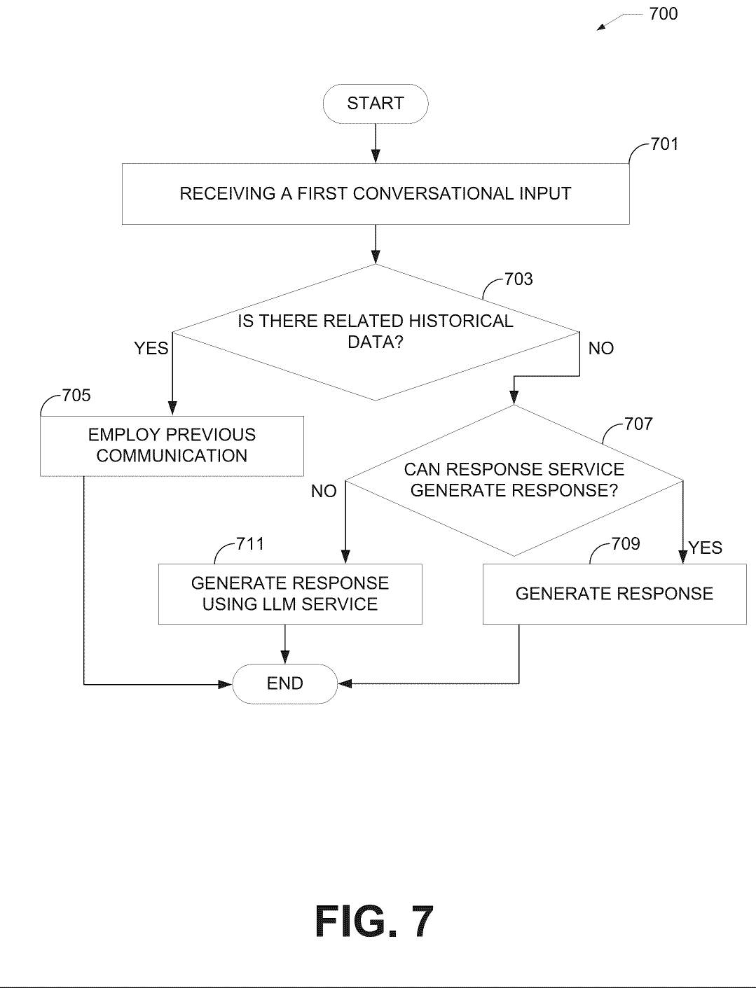

Referring now to FIG. 7, illustrated is a process 700, according to one embodiment of the present disclosure. The process 700 can demonstrate a technique for minimizing calls to the LLM service 208. The LLM service 208 may incur a financial cost when calling to one or more large language models (e.g., ChatGPT, Bard, etc.). To reduce the financial burden of making calls to the LLM service 208, the contextual response system 201 can determine if calling the LLM service 208 is appropriate.

At step 701, the process 700 can include receiving the first conversational input. The contextual response system 201 can receive the first conversational input. The NLP service 205 can extract one or more contexts 214 and/or intents 215 from the conversational inputs.

At step 703, the process 700 can include determining if there is related historical data. The NLP service 205 and/or the communication service 204 can determine if there is related historical data. Historical data can include historical inputs 213, historical responses 216, associated historical contexts 214, associated historical intents 215, and/or any other information from past communications with the contextual response system 201. If the NLP service 205 identifies past communications associated with the conversational input, the process 700 can proceed to box 705. At box 705, the process 700 can include employing previous communications. The NLP service 205 can use historical data to repopulate previous communications performed with the contextual response system 201. For example, the NLP service 205 can send the historical data to the computing device 203 for rendering in the container 219. The NLP service 205 can employ historical data to generate new responses 216 and/or recycle old responses 216. For example, the NLP service can identify that a current input 213 relates to a question that has been asked 104 times in the past 3 days. Continuing this example, the NLP service 205 can reuse the response 216 generated by the LLM service 208 for the previous inputs 213 to respond to the current input 213. If the NLP service 205 cannot identify past communications associated with the conversational input, the process 700 can proceed to box 707.

At box 707, the process 700 can include determining if the response service 207 can generate the response 216 to the input 213. The NLP service 205 can determine if the response service 207 can generate the response 216 using the intent 215 of the input 213. For example, the NLP service 205 can determine if the intent 215 is associated with the low level of complexity. On determining that the intent 215 is associated with the low level of complexity, the process 700 can proceed to box 709, where the NLP service 205 can send the input 213 to the response service 207 to generating the response 216. The response service 207 can employ one or more controlled responses for the response 216. The controlled responses can include but are not limited to pre-written responses, excerpts from documents associated with the entity, and/or responses 216 generated by the LLM service 208 and verified by the live agent.

At box 711, the process 700 can include generating the response using the LLM service 208. The process 700 can proceed to box 711 on determining that the response service 207 is incapable of responding to the input 213. The NLP service 205 can send the input 213 to the LLM service 208 for generating the response 216. For example, the LLM service 208 can send the input 213, the contexts 214, the intents 215, the knowledge bases 212, and/or any pertinent information to ChatGPT for generating the response 216. On generating the response 216, the contextual response system can store the response and all other associated data and send the response to the computing device 203.

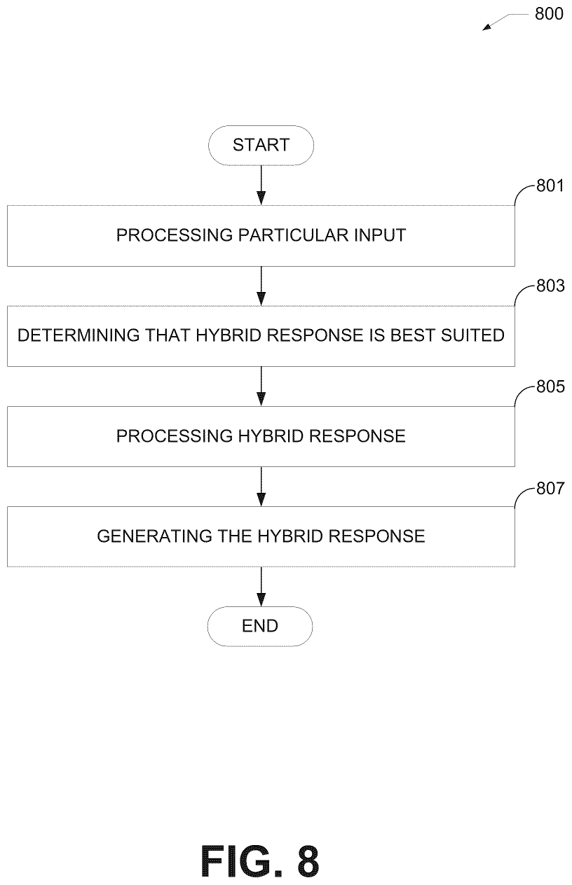

Referring now to FIG. 8, illustrated is a flowchart of a process 800, according to one embodiment of the present disclosure. The process 800 can define a technique for generating a hybrid response based on the particular input 213. The process 800 can be performed by any particular service of the contextual response system 201.

At box 801, the process 800 can include processing a particular input 213. The particular input 213 can correspond to any one or more input received. The communication service 204 and/or the intent router 404 can process the particular input 213. The communication service 204 can determine if the particular input 213 corresponds with a historical conversation. If so, the communication service 204 can re-establish the communication associated with the particular input 213. Reestablishing the communication can include generating metadata or vector data from one or more previous inputs and responses, and using the metadata/vector data in determining a response to the particular input 213. The intent router 404 can process the particular input by generating a vector embedding for the particular input 213. The vector embedding for the particular input 213 can be based in part on metadata/vector data from historical communications. The intent router 404 can compare the vector embedding of the particular input 213 to the vector database 401 to determine pertinent information associated with the particular input 213 and which response type is most appropriate.

At box 803, the process 800 can include determining that a hybrid response is best suited to respond to the particular input 213. The intent router 404 can determine that the hybrid response is best suited to respond to the particular input 213. The intent router 404 can compare the embedding vector of the particular input 213 to the vector database 401 and determine that a particular hybrid response is most closely related to the particular input 213. The intent router 404 can rout the particular input 213, the hybrid response, and/or any other identified information to the response service 207 and/or the prompt engine 403.

At box 805, the process 800 can include processing the hybrid response. The response service 207 and/or the prompt engine 403 can process the hybrid response. The response service 207 can extract the code snippets from the hybrid response and aggregate any subsets of specific data associated with the code snippets. The response service 207 can employ the particular input 213, the hybrid response, the subset of specific data, and/or any other pertinent information to generate the specialized prompt for the LLM service 208. For example, the response service 207 can send the particular input 213, the hybrid response, the subset of specific data, and/or any other pertinent information to the LLM service 208 to generate the specialized prompt that closely aligns with the particular input 213. The LLM service 208 can generate the specialized prompt and the response service 207 can store the specialized prompt in the knowledge base 212 for future use.

At box 807, the process 800 can include generating the hybrid response. The response service 207 can generate the hybrid response. The response service 207 can call the LLM service 208 at any instance in the hybrid response where a particular code snippet is present. The response service 207 can query into the LLM service 208 with the specialized prompt, the subset of specific data, and the particular input 213 to generate text associated with the code snippet. The response service 207 can replace the code snippet with the generated text from the LLM service 208. The response service 207 can continue to generate text for each code snippet until the hybrid response is complete with full textual information. The response service 207 can generate the hybrid response as the response 216 and send the response to the container 219.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, example screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An example system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are example and other mechanisms of establishing communications over wide area networks or the Internet may be used.

Clause 1. A system, comprising: a data store; and at least one computing device in communication with the memory, wherein the at least one computing device is configured to: receive a first conversational input of a plurality of sequential conversational inputs via at least one user input device, wherein the first conversational input is associated with a particular uniform resource locator (URL) address; process the first conversational input via at least one natural language processing (NLP) algorithm to determine at least one intent based on the first conversational input; select at least one data segment from the data store based on the at least one intent; generate a command comprising the at least one data segment; generate a generative response by performing the command with a generative artificial intelligence (AI) algorithm; and provide a response to the first conversational input based on the generative response.

Clause 2. The system of clause 1 or any other clause herein, wherein the at least one computing device is further configured to: receive a second conversational input of the plurality of sequential conversational inputs; process the second conversational input via the at least one natural language processing (NLP) algorithm to: determine a context based on the second conversational input; and determine at least one second intent based on context and the second conversational input; and identify a predetermined response to the second conversational input from the data store based on the at least one intent.

Clause 3. The system of clause 1 or any other clause herein, wherein the at least one computing device is further configured to select the at least one data segment from the data store based on the at least one intent.

Clause 4. The system of clause 1 or any other clause herein, wherein the at least one computing device is further configured to process the first conversational input via at least one natural language processing (NLP) algorithm to determine a context based on the particular URL address and the first conversational input.

Clause 5. The system of clause 4 or any other clause herein, wherein the at least one computing device is further configured to select the at least one data segment from the data store based on the context.

Clause 6. The system of clause 4 or any other clause herein, wherein the at least one computing device is further configured to determine the at least one intent based on the context.

Clause 7. The system of clause 1 or any other clause herein, wherein the at least one computing device is further configured to: generate a plurality of generative responses individually corresponding to a plurality of generative AI algorithms, wherein the plurality of generative responses comprise the generative response and the plurality of generative AI algorithms comprise the generative AI algorithm; score each of the plurality of generative responses; select a highest scored generative response of the plurality of generative responses; and provide the highest scored generative response as the response to the first conversational input based on the score.

Clause 8. The system of clause 1 or any other clause herein, wherein the at least one computing device is further configured to: score the generative response using a second NLP algorithm; and provide the generative response as the response to the first conversational input based on the score.

Clause 9. The system of clause 1 or any other clause herein, wherein the at least one computing device is further configured to: score the generative response using a second NLP algorithm; and based on the score, modify the generative response to comply with at least one guideline; and provide the modified generative response as the response to the first conversational input.

Clause 10. A method, comprising: receiving, via one of one or more computing devices, a first conversational input of a plurality of sequential conversational inputs via at least one user input device, wherein the first conversational input is associated with a particular uniform resource locator (URL) address; processing, via one of the one or more computing devices, the first conversational input via at least one natural language processing (NLP) algorithm to determine at least one intent based on the first conversational input; selecting, via one of the one or more computing devices, at least one data segment from a data store based on the at least one intent; generating, via one of the one or more computing devices, a command comprising the at least one data segment; generating, via one of the one or more computing devices, a generative response by performing the command with a generative artificial intelligence (AI) algorithm; and providing, via one of the one or more computing devices, a response to the first conversational input based on the generative response.

Clause 11. The method of clause 10 or any other clause herein, further comprising: receiving, via one of the one or more computing devices, a second conversational input of the plurality of sequential conversational inputs; processing, via one of the one or more computing devices, the second conversational input via the at least one natural language processing (NLP) algorithm to: determine a context based on the second conversational input; and determine at least one second intent based on context and the second conversational input; and identifying, via one of the one or more computing devices, a predetermined response to the second conversational input from the data store based on the at least one intent.

Clause 12. The method of clause 10 or any other clause herein, further comprising selecting, via one of the one or more computing devices, the at least one data segment from the data store based on the at least one intent.

Clause 13. The method of clause 10 or any other clause herein, further comprising processing, via one of the one or more computing devices, the first conversational input via at least one natural language processing (NLP) algorithm to determine a context based on the particular URL address and the first conversational input.

Clause 14. The method of clause 13 or any other clause herein, further comprising selecting, via one of the one or more computing devices, the at least one data segment from the data store based on the context.

Clause 15. The method of clause 13 or any other clause herein, further comprising determining, via one of the one or more computing devices, the at least one intent based on the context.

Clause 16. The method of clause 10 or any other clause herein, further comprising: generating, via one of the one or more computing devices, a plurality of generative responses individually corresponding to a plurality of generative AI algorithms, wherein the plurality of generative responses comprise the generative response and the plurality of generative AI algorithms comprise the generative AI algorithm; scoring, via one of the one or more computing devices, each of the plurality of generative responses; selecting, via one of the one or more computing devices, a highest scored generative response of the plurality of generative responses; and providing, via one of the one or more computing devices, the highest scored generative response as the response to the first conversational input based on the score.

Clause 17. The method of clause 10 or any other clause herein, further comprising: scoring, via one of the one or more computing devices, the generative response using a second NLP algorithm; and providing, via one of the one or more computing devices, the generative response as the response to the first conversational input based on the score.

Clause 18. The method of clause 10 or any other clause herein, further comprising: scoring, via one of the one or more computing devices, the generative response using a second NLP algorithm; and based on the score, modifying, via one of the one or more computing devices, the generative response to comply with at least one guideline; and providing, via one of the one or more computing devices, the modified generative response as the response to the first conversational input.

Clause 19. A non-transitory computer-readable medium embodying a program that, when executed by at least one computing device, causes the at least one computing device to: receive a first conversational input of a plurality of sequential conversational inputs via at least one user input device, wherein the first conversational input is associated with a particular uniform resource locator (URL) address; process the first conversational input via at least one natural language processing (NLP) algorithm to determine at least one intent based on the first conversational input; select at least one data segment from a data store based on the at least one intent; generate a command comprising the at least one data segment; generate a generative response by performing the command with a generative artificial intelligence (AI) algorithm; and provide a response to the first conversational input based on the generative response.

Clause 20. The non-transitory computer-readable medium of clause 19 or any other clause herein, wherein the program further causes at least one computing device to: receive a second conversational input of the plurality of sequential conversational inputs; process the second conversational input via the at least one natural language processing (NLP) algorithm to: determine a context based on the second conversational input; and determine at least one second intent based on context and the second conversational input; and identify a predetermined response to the second conversational input from the data store based on the at least one intent.

Clause 21. The non-transitory computer-readable medium of clause 19 or any other clause herein, wherein the program further causes at least one computing device to select the at least one data segment from the data store based on the at least one intent.

Clause 22. The non-transitory computer-readable medium of clause 19 or any other clause herein, wherein the program further causes at least one computing device to process the first conversational input via at least one natural language processing (NLP) algorithm to determine a context based on the particular URL address and the first conversational input.

Clause 23. The non-transitory computer-readable medium of clause 22 or any other clause herein, wherein the program further causes at least one computing device to select the at least one data segment from the data store based on the context.

Clause 24. The non-transitory computer-readable medium of clause 22 or any other clause herein, wherein the program further causes at least one computing device to determine the at least one intent based on the context.

Clause 25. The non-transitory computer-readable medium of clause 19 or any other clause herein, wherein the program further causes at least one computing device to: generate a plurality of generative responses individually corresponding to a plurality of generative AI algorithms, wherein the plurality of generative responses comprise the generative response and the plurality of generative AI algorithms comprise the generative AI algorithm; score each of the plurality of generative responses; select a highest scored generative response of the plurality of generative responses; and provide the highest scored generative response as the response to the first conversational input based on the score.

Clause 26. The non-transitory computer-readable medium of clause 19 or any other clause herein, wherein the program further causes at least one computing device to: score the generative response using a second NLP algorithm; and provide the generative response as the response to the first conversational input based on the score.

Clause 27. The non-transitory computer-readable medium of clause 19 or any other clause herein, wherein the program further causes at least one computing device to: score the generative response using a second NLP algorithm; and based on the score, modify the generative response to comply with at least one guideline; and provide the modified generative response as the response to the first conversational input.

While various aspects and clauses have been described in the context of a embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, clauses, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the example embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the example embodiments described therein.

What is claimed is:

1. A system, comprising:
a data store; and
at least one computing device in communication with the memory, wherein the at least one computing device is configured to:
receive a first conversational input of a plurality of sequential conversational inputs via at least one user input device, wherein the first conversational input is associated with a particular uniform resource locator (URL) address;
process the first conversational input via at least one natural language processing (NLP) algorithm to determine at least one intent based on the first conversational input;
select at least one data segment from the data store based on the at least one intent;
generate a command comprising the at least one data segment;
generate a generative response by performing the command with a generative artificial intelligence (AI) algorithm; and
provide a response to the first conversational input based on the generative response.

2. The system of claim 1, wherein the at least one computing device is further configured to:
receive a second conversational input of the plurality of sequential conversational inputs;
process the second conversational input via the at least one natural language processing (NLP) algorithm to:
determine a context based on the second conversational input; and
determine at least one second intent based on context and the second conversational input; and
identify a predetermined response to the second conversational input from the data store based on the at least one intent.

3. The system of claim 1, wherein the at least one computing device is further configured to process the first conversational input via at least one natural language processing (NLP) algorithm to determine a context based on the particular URL address and the first conversational input.

4. The system of claim 1, wherein the at least one computing device is further configured to:
generate a plurality of generative responses individually corresponding to a plurality of generative AI algorithms, wherein the plurality of generative responses comprise the generative response and the plurality of generative AI algorithms comprise the generative AI algorithm;
score each of the plurality of generative responses;
select a highest scored generative response of the plurality of generative responses; and
provide the highest scored generative response as the response to the first conversational input based on the score.

5. The system of claim 1, wherein the at least one computing device is further configured to:
score the generative response using a second NLP algorithm; and
provide the generative response as the response to the first conversational input based on the score.

6. The system of claim 1, wherein the at least one computing device is further configured to:
score the generative response using a second NLP algorithm; and
based on the score, modify the generative response to comply with at least one guideline; and
provide the modified generative response as the response to the first conversational input.

7. A method, comprising:
receiving, via one of one or more computing devices, a first conversational input of a plurality of sequential conversational inputs via at least one user input device, wherein the first conversational input is associated with a particular uniform resource locator (URL) address;
processing, via one of the one or more computing devices, the first conversational input via at least one natural language processing (NLP) algorithm to determine at least one intent based on the first conversational input;
selecting, via one of the one or more computing devices, at least one data segment from a data store based on the at least one intent;
generating, via one of the one or more computing devices, a command comprising the at least one data segment;
generating, via one of the one or more computing devices, a generative response by performing the command with a generative artificial intelligence (AI) algorithm; and
providing, via one of the one or more computing devices, a response to the first conversational input based on the generative response.

8. The method of claim 7, further comprising:
receiving, via one of the one or more computing devices, a second conversational input of the plurality of sequential conversational inputs;
processing, via one of the one or more computing devices, the second conversational input via the at least one natural language processing (NLP) algorithm to:
determine a context based on the second conversational input; and
determine at least one second intent based on context and the second conversational input; and
identifying, via one of the one or more computing devices, a predetermined response to the second conversational input from the data store based on the at least one intent.

9. The method of claim 7, further comprising selecting, via one of the one or more computing devices, the at least one data segment from the data store based on the at least one intent.

10. The method of claim 7, further comprising processing, via one of the one or more computing devices, the first conversational input via at least one natural language processing (NLP) algorithm to determine a context based on the particular URL address and the first conversational input.

11. The method of claim 7, further comprising:
generating, via one of the one or more computing devices, a plurality of generative responses individually corresponding to a plurality of generative AI algorithms, wherein the plurality of generative responses comprise the generative response and the plurality of generative AI algorithms comprise the generative AI algorithm;
scoring, via one of the one or more computing devices, each of the plurality of generative responses;
selecting, via one of the one or more computing devices, a highest scored generative response of the plurality of generative responses; and
providing, via one of the one or more computing devices, the highest scored generative response as the response to the first conversational input based on the score.

12. The method of claim 7, further comprising:
scoring, via one of the one or more computing devices, the generative response using a second NLP algorithm; and
based on the score, modifying, via one of the one or more computing devices, the generative response to comply with at least one guideline; and
providing, via one of the one or more computing devices, the modified generative response as the response to the first conversational input.

13. A non-transitory computer-readable medium embodying a program that, when executed by at least one computing device, causes the at least one computing device to:
receive a first conversational input of a plurality of sequential conversational inputs via at least one user input device, wherein the first conversational input is associated with a particular uniform resource locator (URL) address;
process the first conversational input via at least one natural language processing (NLP) algorithm to determine at least one intent based on the first conversational input;
select at least one data segment from a data store based on the at least one intent;
generate a command comprising the at least one data segment;
generate a generative response by performing the command with a generative artificial intelligence (AI) algorithm; and
provide a response to the first conversational input based on the generative response.

14. The non-transitory computer-readable medium of claim 13, wherein the program further causes at least one computing device to:
receive a second conversational input of the plurality of sequential conversational inputs;
process the second conversational input via the at least one natural language processing (NLP) algorithm to:
determine a context based on the second conversational input; and
determine at least one second intent based on context and the second conversational input; and
identify a predetermined response to the second conversational input from the data store based on the at least one intent.

15. The non-transitory computer-readable medium of claim 13, wherein the program further causes at least one computing device to process the first conversational input via at least one natural language processing (NLP) algorithm to determine a context based on the particular URL address and the first conversational input.

16. The non-transitory computer-readable medium of claim 15, wherein the program further causes at least one computing device to select the at least one data segment from the data store based on the context.

17. The non-transitory computer-readable medium of claim 15, wherein the program further causes at least one computing device to determine the at least one intent based on the context.

18. The non-transitory computer-readable medium of claim 13, wherein the program further causes at least one computing device to:
generate a plurality of generative responses individually corresponding to a plurality of generative AI algorithms, wherein the plurality of generative responses comprise the generative response and the plurality of generative AI algorithms comprise the generative AI algorithm;
score each of the plurality of generative responses;
select a highest scored generative response of the plurality of generative responses; and
provide the highest scored generative response as the response to the first conversational input based on the score.

19. The non-transitory computer-readable medium of claim 13, wherein the program further causes at least one computing device to:
score the generative response using a second NLP algorithm; and
provide the generative response as the response to the first conversational input based on the score.

20. The non-transitory computer-readable medium of claim 13, wherein the program further causes at least one computing device to:
score the generative response using a second NLP algorithm; and
based on the score, modify the generative response to comply with at least one guideline; and
provide the modified generative response as the response to the first conversational input.
